(19) United States
(12) Patent Application Publication
(10) Pub. No.: US 2026/0229552 A1
(43) Pub. Date: Aug. 6, 2026

(54) ELECTRODE MATERIALS FOR MEMBRANE ELECTRODE ASSEMBLY

(71) Applicant: Ecolectro, Inc., lthaca, NY (US)

(72) Inventors: Kristina Hugar, Ithaca, NY (US); Christopher Simoneau, Ithaca, NY (US); Ryan Selhorst, Ithaca, NY (US)

(21) Appl. No.: 19/152,617

(22) PCT Filed: Jan. 31, 2024
(86) PCT No.: PCT/US2024/013736

§ 371 Date: Jul. 31, 2025

Related U.S. Application Data
(60) Provisional application No. 63/442,599, filed on Feb. 1, 2023.

(51) Int. Cl. H01M 4/86; C25B 9/19; C25B 11/04; H01M 4/90; H01M 8/04119; H01M 8/1004

(52) U.S. Cl. CPC H01M 4/8668; C25B 9/19; C25B 11/04; H01M 4/9016; H01M 8/04126; H01M 8/1004

(57) ABSTRACT

The present disclosure relates to a membrane electrode assembly comprising a support and a catalyst/ionomer layer, said catalyst/ionomer layer comprising a cross-linked ionomer. The present disclosure further relates to methods of manufacturing the membrane electrode assemblies, as well as electrochemical devices comprising the disclosed membrane electrode assemblies.

### RELATED APPLICATIONS

This application claims the benefit of priority to U.S. Provisional Application No. 63/442,599 filed on Feb. 1, 2023. The entire teachings of the above application are incorporated herein by reference.

### GOVERNMENT SUPPORT

This invention was made with Government support under Grant No. DE-AR0001058 awarded by the U.S. Department of Energy. The Government has certain rights in the invention.

### BACKGROUND OF THE INVENTION

Alkaline exchange membrane (AEM) based electrolyzers and fuel cells are cost-effective, industrially important alternatives to proton exchange membranes (PEM) and traditional alkaline exchange devices.

An AEM electrolyzer or fuel cell contains a membrane electrode assembly (MEA), which comprises a catalyst/ionomer layer. The metal catalyst facilitates the reduction/oxidation reactions and provides a continuous electrical network for electron transportation, while the ionomer layer provides an ionic network for anion transport between the AEM and catalyst, facilitating water management within the cell, and acting as a binder for catalyst adhesion and overall mechanical integrity between the layers of the MEA.

Therefore, high-performance catalyst/ionomer layers that are resistant to thermal and chemical degradation under the harsh chemical environment and high temperatures of devices such a fuel cells and electrolyzers are needed.

### SUMMARY OF THE INVENTION

In a first example embodiment, the present disclosure relates to a membrane electrode assembly (MEA), comprising:
a support, and
a catalyst/ionomer layer, said catalyst/ionomer layer comprising a first cross-linked ionomer and a catalyst, wherein the first cross-linked ionomer comprises:
a plurality of first repeat units, wherein each first repeat unit is a moiety represented by a structural formula

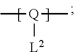

a plurality of second repeat units, wherein each second repeat unit is a moiety represented by a structural formula

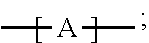

and a plurality of cross-linking moieties, wherein each cross-linking moiety is represented by structural formula (I) or (II):

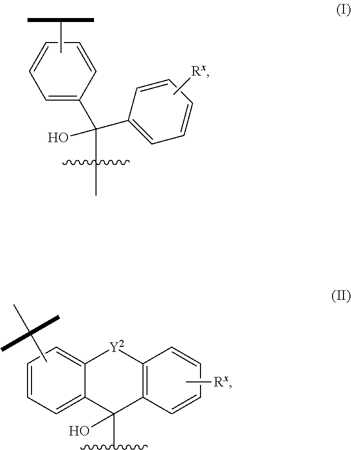

wherein, for each occurrence of the cross-linking moiety, the symbol [symbol] represents a point of attachment to L² and the symbol [symbol] represents a point of attachment to a first repeat unit or a second repeat unit;
and further wherein:

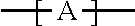

is a moiety represented by the following structural formula:

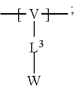

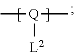

is a moiety represented by one of the following structural formulas:

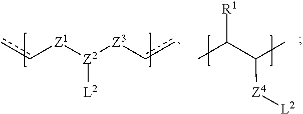

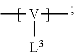

is a moiety represented by one of the following structural formulas:

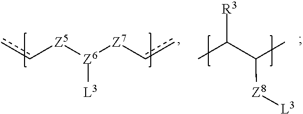

W is C₁₋₁₂ alkyl or a moiety represented by one of the structural formulas selected from:

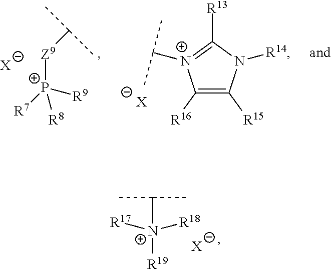

wherein:
   the symbol [symbol] represents a point of attachment to L³, and the symbol [symbol] represents a double bond or a single bond; [symbol]
   Z¹, Z³, Z⁵, and Z⁷ each independently is a C₁₋₃ alkylene or a bond;
   R¹ is selected from H, a C₁₋₁₂ alkyl, and C₆₋₁₂ aryl, and
   Z⁴ is a bond or a C₆₋₁₂ arylene, or
   Z⁴ is CH, and R¹ and Z⁴ together with the C₂ alkylene to which they are attached form a C₅₋₁₂ cycloalkyl or a 5 to 12-membered heterocyclyl; and
   Z⁶ is selected from —CHR⁶—, a C₅₋₁₂ cycloalkylene, and a 5 to 16-membered heterocyclylene;
   R³ is selected from H, a C₁₋₁₂ alkyl, and C₆₋₁₂ aryl, and
   Z⁸ is a bond or a C₆₋₁₂ arylene, and CH, or
   Z⁸ is CH, and R³ and Z⁸ together with the C₂ alkylene to which they are attached form a C₅₋₁₂ cycloalkyl or a 5 to 12-membered heterocyclyl; and
   Z⁹ is NR¹⁰ or a bond;
   R⁵ and R⁶ each independently is H or a C₁₋₁₂ alkyl;
   R⁷, R⁸, and R⁹ each independently is selected from NR¹¹R¹², a C₆₋₁₂ aryl, and 5 to 12-membered heterocyclyl;
   R¹⁰ is a C₁₋₁₂ alkyl;
   R¹¹ and R¹² each independently is C₁₋₁₂ alkyl or a C₃₋₁₂ cycloalkyl, or R¹¹ and R¹² together with the nitrogen atom to which they are attached form a 5 to 12-membered heterocyclyl;
   R¹³ is selected from a C₁₋₁₂ alkyl, C₆₋₁₂ aryl, and 5 to 12-membered heterocyclyl;
   R¹⁴ is a C₁₋₁₂ alkyl or a C₃₋₁₂ cycloalkyl;
   R¹⁵ and R¹⁶ each independently is selected from C₁₋₁₂ alkyl, C₆₋₁₂ aryl, and 5 to 12-membered heterocyclyl; or R¹⁵ and R¹⁶ together with the carbon atoms to which they are attached form a C₆₋₁₂ aryl or a 5 to 12-membered heterocyclyl; and
   R¹⁷, R¹⁸, and R¹⁹ each independently is a C₁₋₁₂ alkyl or a C₃₋₁₂ cycloalkyl; or
   R¹⁸ and R¹⁹ together with the nitrogen atom to which they are attached form a 5 to 12-membered heterocyclyl and (i) R¹⁷ is a C₁₋₁₂ alkyl or a C₃₋₁₂ cycloalkyl, or (ii) R¹⁷ and at least one atom of L³ together with the nitrogen atom to which L³ and R¹⁷ are attached form a 5- to 12-membered heterocyclyl; or
   R¹⁷, R¹⁸, and R¹⁹ together with the nitrogen atom to which they are attached form a bicyclic 5 to 12-membered heterocyclyl; and
   R^{x} is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl;
   L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ; L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁-12 alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond;
   m is an integer between 1 and 6;
   n is an integer between 1 and 6;
   Y² is selected from —C(O)—, —O—, —S—, —NH—, —N(C₁₋₁₂ alkyl)-, and a bond;
   X⁻ is selected from F⁻, Cl⁻, Br⁻, OH⁻, NO⁻₂, CN⁻, HCO₃⁻, CO₃²⁻, PF₆⁻, BF₄⁻, and a C₁₋₁₂ carboxylate;
   provided that W is C₁₋₁₂ alkyl only when V is a cationic moiety,
and wherein:
   each C₁₋₁₂ alkylene, C₆₋₁₂ arylene, C₅₋₁₂ cycloalkylene, 5 to 16-membered heterocyclylene, C₁₋₁₂ alkyl, C₃₋₁₂ cycloalkyl, C₅₋₁₂ cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

In a second example embodiment the present disclosure relates to a method of making an MEA as described herein with respect to the first embodiment and various aspects thereof, comprising:
a) providing a suspension comprising a solution of a cross-linkable ionomer and the catalyst in a solvent,
b) contacting the support with the suspension, thereby producing a coated support, and
c) exposing the coated support to ultraviolet radiation for a time sufficient to cross-link the cross-linkable ionomer, wherein
   the cross-linkable ionomer comprises:
      a plurality of first repeat units represented by structural formula (III):

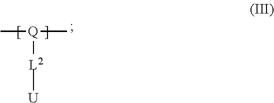

and
a plurality of second repeat units represented by structural formula (IV):

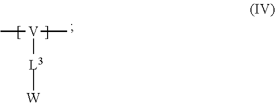

wherein:

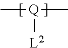

is a moiety represented by one of the following structural formulas:

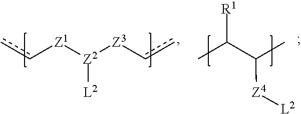

U is a moiety represented by one of the following structural formulas:

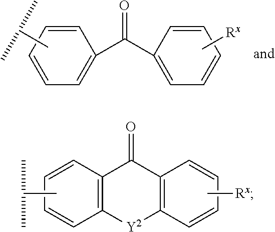

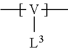

is a moiety represented by one of the following structural formulas:

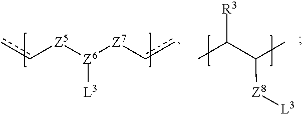

W is a C₁₋₁₂ alkyl or a moiety represented by one of the structural formulas selected from:

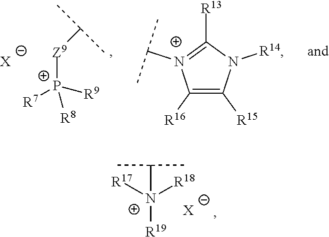

wherein:
for each occurrence, the symbol [symbol] represents a point of attachment to L²; the symbol [symbol] is represents a point of attachment to L³; and the symbol [symbol] represents a double bond or a single bond;
Z¹, Z³, Z⁵, and Z⁷ each independently is a C₁₋₃ alkylene or a bond;
Z² is selected from —CHR⁵—, a C₅₋₁₂ cycloalkylene, and a 5 to 16-membered heterocyclylene;
R¹ is selected from H, a C₁₋₁₂ alkyl, and C₆₋₁₂ aryl, and
Z⁴ is a bond or a C₆₋₁₂ arylene, or
Z⁴ is CH, and R¹ and Z⁴ together with the C₂ alkylene to which they are attached form a C₅₋₁₂ cycloalkyl or a 5 to 12-membered heterocyclyl; and
Z⁶ is selected from —CHR⁶—, a C₅₋₁₂ cycloalkylene, and a 5 to 16-membered heterocyclylene;
R³ is selected from H, a C₁₋₁₂ alkyl, and C₆₋₁₂ aryl, and
Z⁸ is a bond or a C₆₋₁₂ arylene, and CH, or
Z⁸ is CH, and R³ and Z⁸ together with the C₂ alkylene to which they are attached form a C₅₋₁₂ cycloalkyl or a 5 to 12-membered heterocyclyl; and
Z⁹ is NR¹⁰ or a bond;
R⁵ and R⁶ each independently is H or a C₁₋₁₂ alkyl;
R⁷, R⁸, and R⁹ each independently is selected from NR¹¹R¹², a C₆₋₁₂ aryl, and 5 to 12-membered heterocyclyl;
R¹⁰ is a C₁₋₁₂ alkyl;
R¹¹ and R¹² each independently is C₁₋₁₂ alkyl or a C₃₋₁₂ cycloalkyl, or R¹¹ and R¹² together with the nitrogen atom to which they are attached form a 5 to 12-membered heterocyclyl;
R¹³ is selected from a C₁₋₁₂ alkyl, C₆₋₁₂ aryl, and 5 to 12-membered heterocyclyl;
R¹⁴ is a C₁₋₁₂ alkyl or a C₃₋₁₂ cycloalkyl;
R¹⁵ and R¹⁶ each independently is selected from C₁₋₁₂ alkyl, C₆₋₁₂ aryl, and 5 to 12-membered heterocyclyl; or R¹⁵ and R¹⁶ together with the carbon atoms to which they are attached form a C₆₋₁₂ aryl or a 5 to 12-membered heterocyclyl; and
R¹⁷, R¹⁸, and R¹⁹ each independently is a C₁₋₁₂ alkyl or a C₃₋₁₂ cycloalkyl; or
R¹⁸ and R¹⁹ together with the nitrogen atom to which they are attached form a 5 to 12-membered heterocyclyl and (i) R¹⁷ is a C₁₋₁₂ alkyl or a C₃₋₁₂ cycloalkyl, or (ii) R¹⁷ and at least one atom of L³, if present, together with the nitrogen atom to which L³ and R¹⁷ are attached form a 5- to 12-membered heterocyclyl; or
R¹⁷, R¹⁸, and R¹⁹ together with the nitrogen atom to which they are attached form a bicyclic 5 to 12-membered heterocyclyl; and
R^{x} is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl;
L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ;
L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond;
m is an integer between 1 and 6;
n is an integer between 1 and 6;
Y² is selected from —C(═O)—, O, S, NH, N(C₁₋₁₂ alkyl), and a bond;
X⁻ is selected from F⁻, Cl⁻, Br⁻, OH⁻, NO⁻₂, CN⁻, HCO₃⁻, CO₃²⁻, PF₆⁻, BF₄⁻, a C₁₋₁₂ carboxylate and a C₁₋₁₂ alkoxide;
provided that W is C₁₋₁₂ alkyl only when V is a cationic moiety, and wherein:
each C₁₋₁₂ alkylene, C₆₋₁₂ arylene, C₅₋₁₂ cycloalkylene, 5 to 16-membered heterocyclylene, C₁₋₁₂ alkyl, C₃₋₁₂ cycloalkyl, C₅₋₁₂ cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

In a third example embodiment the present disclosure relates to a fuel cell comprising an MEA described herein with respect to the first embodiment and various aspects thereof, a source of fuel, and an oxidant.

In a fourth example embodiment the present disclosure relates to an electrolyzer comprising an MEA described herein with respect to the first embodiment and various aspects thereof and an electrolyte source.

### BRIEF DESCRIPTION OF THE DRAWINGS

FIG. 1 is a plot demonstrating current densities of AEM devices comprising a non-crosslinked catalyst/ionomer layer (A) and UV cross-linked catalyst/ionomer layer (B).

### DETAILED DESCRIPTION

An MEA is composed of an outer gas diffusion layer, catalyst/ionomer layers, and an internal AEM. MEAs can be configured in such a way that the catalyst/ionomer layer is deposited directly on the gas diffusion layers to form a gas diffusion electrode (GDE) or on the AEM directly as a catalyst coated membrane (CCM).

An alkaline exchange ionomer (AEI) is a cationic polymer with the ability to conduct hydroxide anions within the MEA of an electrolyzer and fuel cell device. Suitable AEIs for water electrolyzers and fuel cells are often characterized as having high hydroxide conductivity, modest water absorption properties, and solubility in organic solvents. Poor performance or durability within an electrochemical device, such as an electrolyzer or fuel cell, is often attributed to either chemical or mechanical degradation of the AEI within the catalyst/ionomer layer. During operation, GDE or CCM components are subjected to pressure and electrochemical forces from the flowing electrolytes, incoming or outgoing gases, heat, and applied voltages. These forces result in a physical change of the AEI layer (swelling or deformation) resulting in a delamination of the catalyst layer from the GDE or CCM. The catalyst/ionomer delamination results in the loss of electrical and ionic contact and manifests itself as an increase in device resistance and poor overall performance.

Chemical or mechanical degradation of an AEI in a GDE or CCM leads to a loss of catalyst contact and a reduction in device performance leading to reduced efficiencies, increased maintenance, and reliability issues. Efforts to improve the stability of the catalyst/ionomer in GDEs or CCMs have included direct catalyst functionalization, chemical cross-linking, and the addition of non-conductive adhesives.

The present disclosure describes a catalyst/ionomer composition where the catalyst is dispersed in a cross-linked ionomer matrix. The catalyst/ionomer composition is formed by exposing a mixture of the catalyst and a cross-linkable ionomer containing cationic groups and UV-reactive cross-linking moieties to UV light. The process does not require the use of external cross-linking agents such as dithiols or dialdehydes to achieve mechanically robust electrodes. This eliminates the need for subjecting the electrode assembly to organic reagents post-production or relying on reactions to take place in slurries after coating.

The disclosed approach to the preparation of catalyst/ionomer compositions extends the electrode “cure time” indefinitely without the risk of creating an intractable composite. The process offers cure on demand using UV light to eliminating risk of premature curing. Using photo-catalysis to crosslink the ionomers is advantageous because the ionomers can be synthesized and fabricated in any form factor needed (films, powders, solutions) prior to irreversible cross-linking. UV curing of coatings is common in polymer manufacturing and simplifies the processing for production at larger scale. This is preferred over methods that crosslink in situ or by chemical soaking after fabrication because these methods are difficult to translate in large scale manufacturing.

The cross-linkable ionomers of the disclosure are soluble and processable in organic solvents, unlike other ionomers that are cross-linked prior to making the “catalyst ink”. Efficient mixing, blending, and coating of the ionomer and the catalysts leads to better catalyst/ionomer contact and dispersity. Tape tests examining physical adhesion show improved performance of cross-linked catalyst/ionomer compositions compared to non-cross-linked catalyst/ionomer compositions (see Example 14).

### Ionomers of the Invention

Presented in the below paragraphs are exemplary components (e.g., backbones, repeat units, cationic moieties, or cross-linkable moieties) of cross-linkable AEIs that can be used in the catalyst/ionomer compositions of the disclosure. An AEI can comprise any combination of the components disclosed below.

### 1. Ionomer Backbones

A cross-linkable moiety or a cationic moiety can be incorporated in the polymer by connecting it to a repeat unit. For example, the following repeat units or ionomer backbones can be functionalized with cross-linkable or cationic moieties:

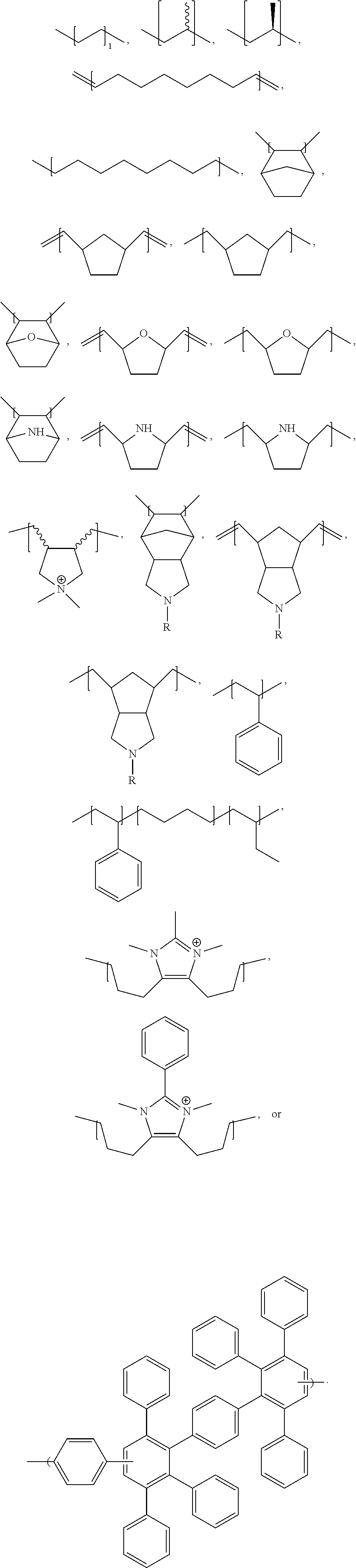

### 2. Cationic Moieties.

The AEIs can comprise various cationic moieties. For example, cationic moieties can be incorporated in an AEI as pendants linked to the backbone of the ionomer. Additionally or alternatively, the backbone of the ionomer can comprise cationic groups. For example, the following cationic moieties can be incorporated in an AEI ( [symbol] indicates the point of attachment of the cationic moiety to the backbone or to a linker connected to the backbone):

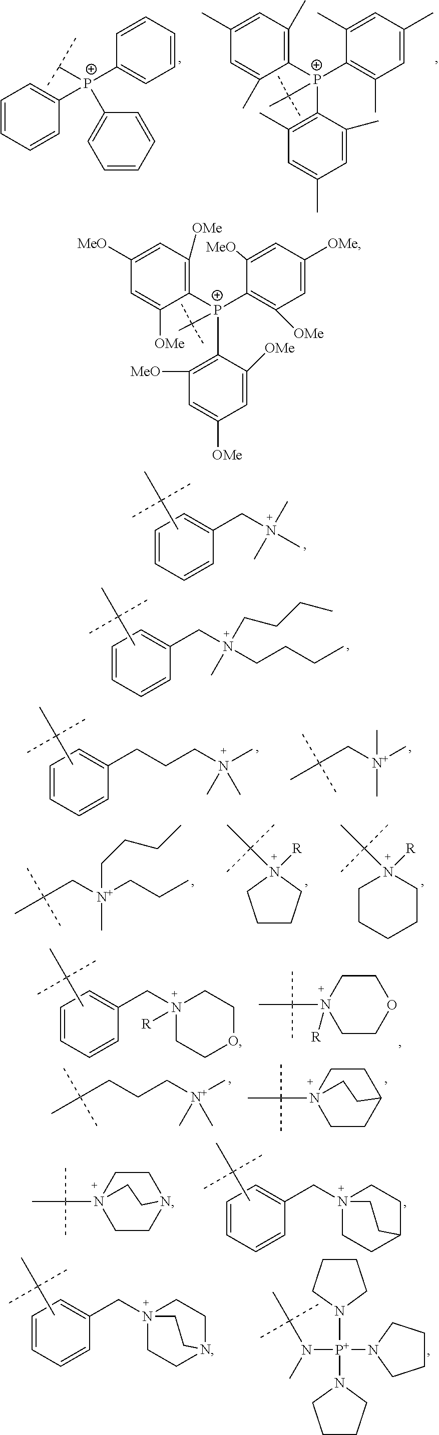

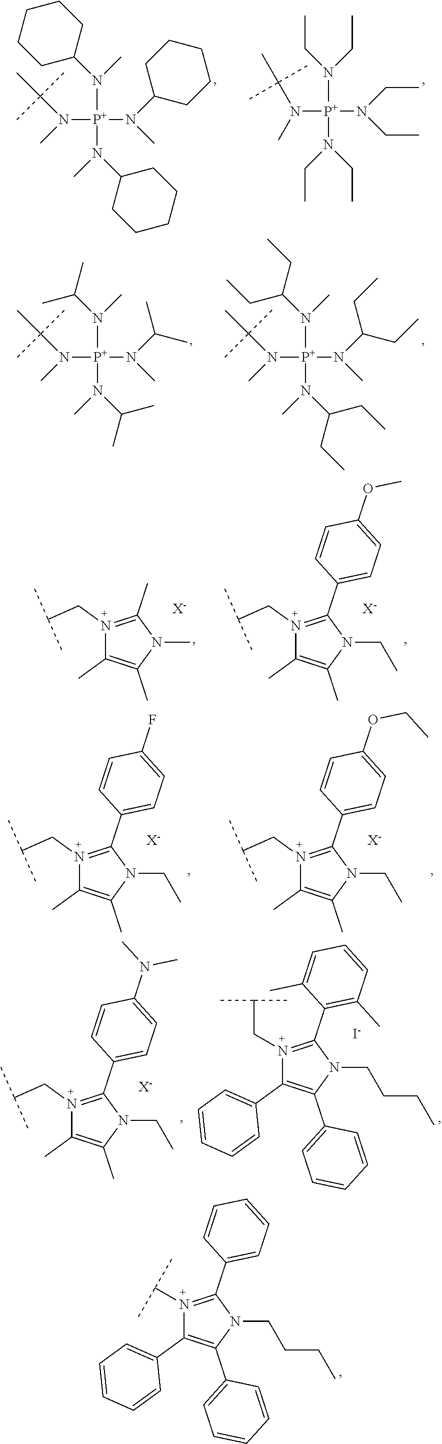

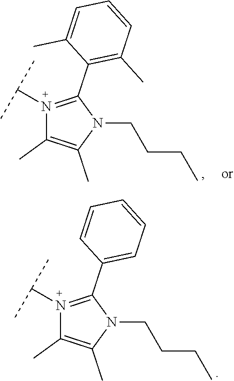

### 3. Cross-Linkable Moieties

The AEIs can comprise, cross-linkable moieties in some of the repeat units of the polymer. The cross-linkable moieties can comprise, for example, type II photoinitiators, e.g., benzophenone, camphorquinone, isopropylthioxanthone, and thioxanthone (see Allushi et al., Polymer Chemistry, 2017, 8, 1972-1977). Type I photoinitiators such as dimethoxyphenylacetophenone, α-hydroxyacetophenone, α-aminoacetophenone, benzoylphosphinoxide, bisbenzoylphosphinoxide, can also be introduced into some of the repeat units of the ionomer.

In some embodiments, the cross-linkable ionomers of this disclosure comprise a type II photoinitiator, such as benzophenone. For example, an ionomer can be prepared by copolymerizing cyclooctene substituted with a benzophenone-containing moiety, cyclooctene substituted with a cationic moiety, and unsubstituted cyclooctene, to yield, for example, the following random copolymer:

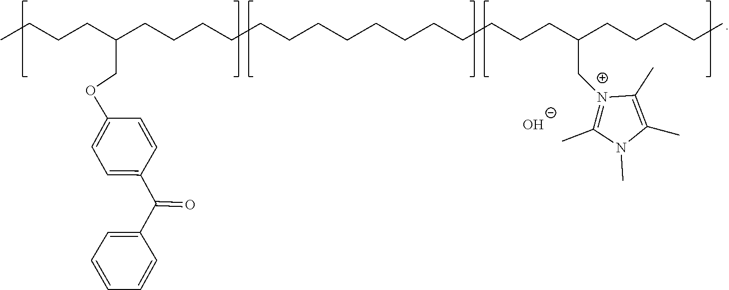

Upon exposure to UV light, the benzophenone pendants in the ionomer undergo UV-activated C,H-insertion reactions to forms covalent C—C bonds with polymer fragments containing aliphatic C—H bonds. Accordingly, the benzophenone-containing moiety can become covalently linked to a CH-containing group in the polymer backbone or the side chain pendant. For example, the after the UV exposure the benzophenone-based crosslinking moiety can be attached to alkylene, alkyl, or cycloalkyl groups in i) the backbone, ii) the cationic moieties; or iii) the linkers attaching the cationic moieties or the benzophenone moieties to the backbone. Such cross-linking can be intramolecular (the covalent bond is formed via C,H-insertion in the same polymer chain) or intermolecular (the covalent bond is formed via C,H-insertion in a different polymer chain). Therefore, upon exposure to UV light, an ionomer comprising benzophenone-containing repeat units forms a cross-linked polymer network. The network can comprise, for example, the following cross-linking moieties:

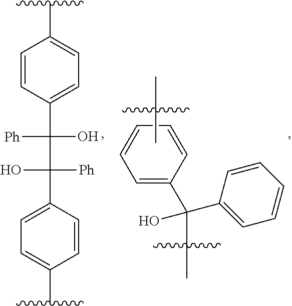

In some embodiments, the AEIs of the disclosure can comprise a diazerene-containing cross-linkable moiety. A diazerene fragment decomposes into a carbene upon exposure to UV light, which enables the cross-linking of essentially any organic polymer through C—H activation:

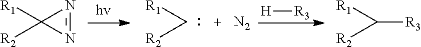

Additionally, the AEIs of the disclosure can comprise crosslinking moieties that undergo UV-initiated [2+2]cycloadditions and [4+4]cycloadditions as shown below:

| Compound | Reaction |
|---|---|
| Anthracene | 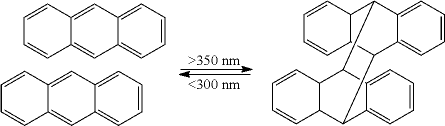 |
| Cinnamic acid | 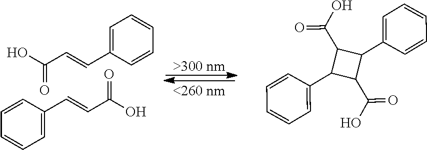 |
| Coumarin | 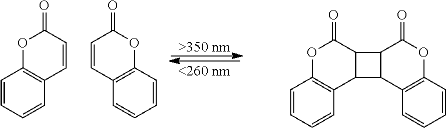 |
| Thymine | 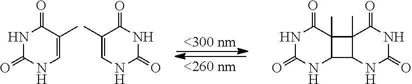 |
| Stilbene | 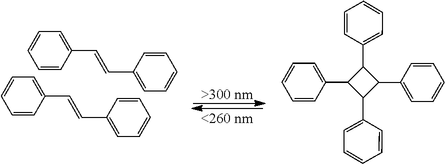 |

In some embodiments, the AEIs of the disclosure can comprise an azide-containing cross-linkable moiety. The azide fragment decomposes into a nitrene upon exposure to UV light, which enables the cross-linking of an organic polymer through C—H activation or recombination of two nitrenes to form a diazo cross-linker:

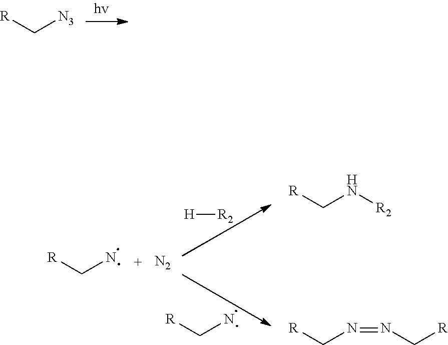

### 4. Repeat Units

In some embodiments, the AEIs of the present disclosure comprise cationic and UV-crosslinkable moieties. Examples of such AEIs are described in the International Patent Application Publication WO 2023/018765, which is incorporated herein by reference in its entirety. In some embodiments, the cross-linkable ionomers of the present disclosure can comprise the following combinations of repeat units:

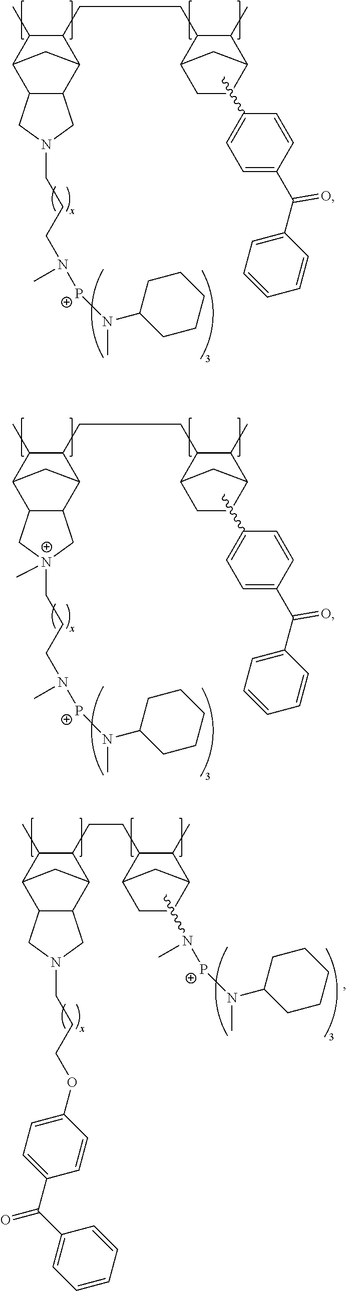

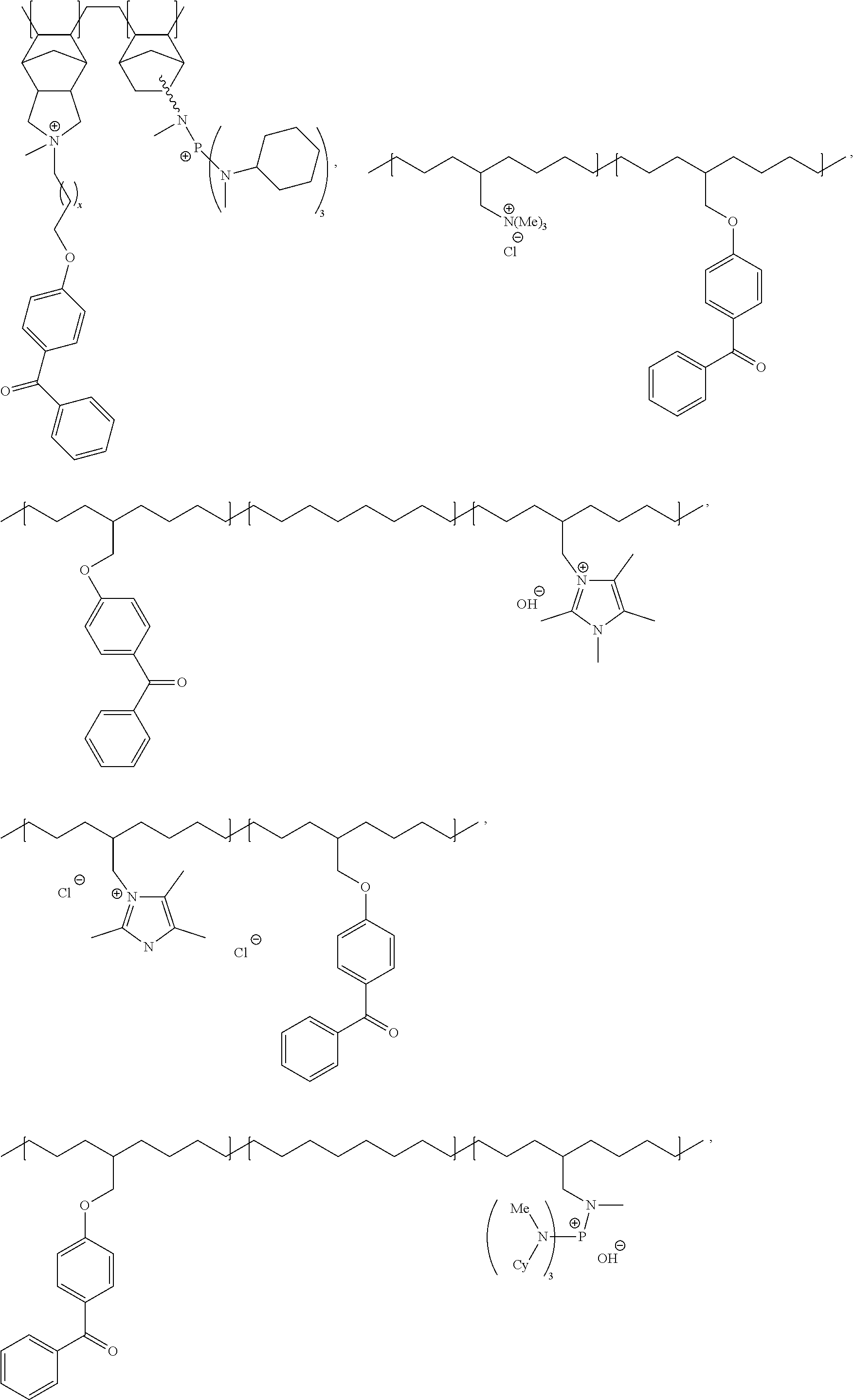

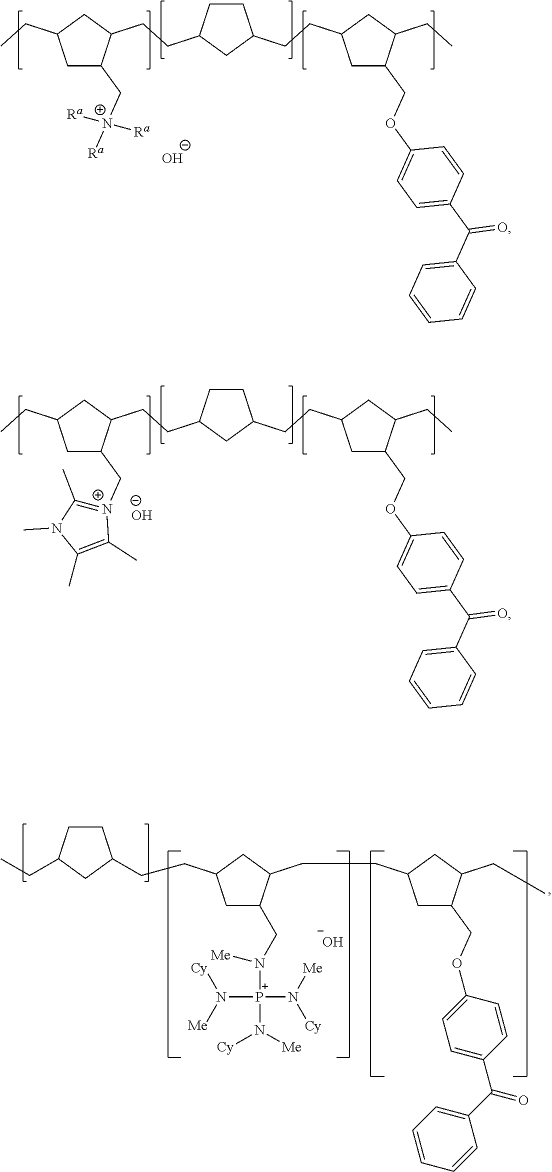

where each R^{a} independently is a C₁₋₁₂ alkyl or a C₃₋₁₂ cycloalkyl.

### Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March, March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions, Wiley Interscience, New York, 1981; Wilen et al., Tetrahedron 33:2725 (1977); Eliel, E. L. Stereochemistry of Carbon Compounds, McGraw-Hill, NY, 1962; and Wilen, S. H., Tables of Resolving Agents and Optical Resolutions p. 268, E. L. Eliel, Ed., Univ. of Notre Dame Press, Notre Dame, IN 1972. The invention additionally encompasses compounds as individual isomers substantially free of other isomers, and alternatively, as mixtures of various isomers.

In a formula, [symbol] or [symbol] is a single or double bond.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkyl” refers to a radical of a straight-chain or branched saturated hydrocarbon group having from 1 to 18 carbon atoms (“C₁₋₁₈ alkyl”). In some embodiments, an alkyl group has 1 to 12 carbon atoms (“C₁₋₁₂ alkyl”). In some embodiments, an alkyl group has 1 to 8 carbon atoms (“C₁₋₈ alkyl”). In some embodiments, an alkyl group has 1 to 6 carbon atoms (“C₁₋₆ alkyl”). In some embodiments, an alkyl group has 1 to 3 carbon atoms (“C₁₋₃ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”). In certain embodiments, the alkyl group is an unsubstituted C₁₋₁₂ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₂ alkyl (such as substituted C₁₋₆ alkyl, e.g., —CF₃, Bn).

The term “haloalkyl” refers to a substituted alkyl group, wherein one or more of the hydrogen atoms are independently replaced by a halogen, e.g., fluoro, bromo, chloro, or iodo. In some embodiments, the haloalkyl moiety has 1 to 12 carbon atoms (“C₁₋₁₂ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “alkoxy” refers to an alkyl group, as defined herein, appended to the parent molecular moiety through an oxygen atom. In some embodiments, the alkoxy moiety has 1 to 12 carbon atoms (“C₁₋₁₂ alkoxy”). In some embodiments, the alkoxy moiety has 1 to 6 carbon atoms (“C₁₋₆ alkoxy”). In some embodiments, the alkoxy moiety has 1 to 4 carbon atoms (“C₁₋₄ alkoxy”). In some embodiments, the alkoxy moiety has 1 to 3 carbon atoms (“C₁₋₃ alkoxy”). In some embodiments, the alkoxy moiety has 1 to 2 carbon atoms (“C₁₋₂ alkoxy”). Representative examples of alkoxy include, but are not limited to, methoxy, ethoxy, propoxy, 2-propoxy, butoxy and tert-butoxy.

In some embodiments, “cycloalkyl” is a radical of a saturated hydrocarbon monocyclic or polycyclic group having from 3 to 18 ring carbon atoms (“C₃₋₁₈ cycloalkyl”). In some embodiments, a cycloalkyl group has 3 to 12 ring carbon atoms (“C₃₋₁₂ cycloalkyl”). In some embodiments, a cycloalkyl group has 3 to 8 ring carbon atoms (“C₃₋₈ cycloalkyl”). In some embodiments, a cycloalkyl group has 5 to 12 ring carbon atoms (“5-12 cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 7 ring carbon atoms (“C₅₋₇ cycloalkyl”). A polycyclic cycloalkyl group can be, for example, bycyclic, tricyclic, or tetracyclic. A polycyclic cycloalkyl group can contain fused cycloalkyl rings. A polycyclic cycloalkyl group can be a spirocyclic cycloalkyl group or a bridged cycloalkyl group. Examples of C₅₋₆ cycloalkyl groups include cyclopentyl (C₅) and cyclohexyl (C₆). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₂ cycloalkyl. In certain embodiments, the cycloalkyl group is a substituted C₃₋₁₂ cycloalkyl. In certain embodiments, the cycloalkyl group is an unsubstituted C₅₋₁₂ cycloalkyl. In certain embodiments, the cycloalkyl group is a substituted C₅₋₁₂ cycloalkyl.

In some embodiments, “cycloalkenyl” is a non-aromatic radical of a hydrocarbon monocyclic or polycyclic group having at least one double bond and from 4 to 18 ring carbon atoms (“C₄₋₁₈ cycloalkenyl”). In some embodiments, a cycloalkenyl group has 4 to 12 ring carbon atoms (“C₄₋₁₂ cycloalkenyl”). In some embodiments, a cycloalkyl group has 4 to 8 ring carbon atoms (“C₄₋₈ cycloalkenyl”). In some embodiments, a cycloalkenyl group has 5 to 12 ring carbon atoms (“5-12 cycloalkenyl”). In some embodiments, a cycloalkenyl group has 7 to 8 ring carbon atoms (“C₇₋₈ cycloalkenyl”). A polycyclic cycloalkenyl group can be, for example, bycyclic, tricyclic, or tetracyclic. A polycyclic cycloalkenyl group can contain a cycloalkenyl ring fused to another cycloalkenyl ring, a cycloalkyl ring, or a heterocyclyl ring. A polycyclic cycloalkenyl group can be a spirocyclic cycloalkenyl group or a bridged cycloalkenyl group. Exemplary cycloalkenyl groups include, without limitation, cyclooctenyl, bicyclooctenyl, and norbornenyl.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₋₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₂ aryl. In certain embodiments, the aryl group is a substituted C₆₋₁₂ aryl.

The term “aryloxy” refers to an aryl group, as defined herein, appended to the parent molecular moiety through an oxygen atom. In some embodiments, the aryloxy moiety has 6 to 12 carbon atoms (“C₆₋₁₂ aryloxy”). In some embodiments, the aryloxy moiety has 6 to 10 carbon atoms (“C₆₋₁₀ aryloxy”). Representative examples of aryloxy include, but are not limited to, phenoxy and naphthoxy.

The term “heterocyclyl” or “heterocyclic” refers to a radical of a 3- to 16-membered saturated, unsaturated non-aromatic, or aromatic ring system having ring carbon atoms and 1 to 4 ring heteroatoms, wherein each heteroatom is independently selected from nitrogen, oxygen, and sulfur (“5-16 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”). Heterocyclyl polycyclic ring systems can include one or more heteroatoms in one or both rings. “Heterocyclyl” also includes ring systems wherein the heterocyclyl ring, as defined above, is fused with one or more cycloalkyl groups wherein the point of attachment is either on the cycloalkyl or heterocyclyl ring, or ring systems wherein the heterocyclyl ring, as defined above, is fused with one or more aryl groups, wherein the point of attachment is on the heterocyclyl ring, and in such instances, the number of ring members continue to designate the number of ring members in the combined fused ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 5-12 membered heterocyclyl. In certain embodiments, the heterocyclyl group is a substituted 5-12 membered heterocyclyl.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

As used herein, the term “heterocycloalkenyl” refers to an unsaturated non-aromatic heterocyclyl group as described above, comprising one or more double bonds. In some embodiments, heterocycloalkenyl groups are bicyclic bridge moieties. In some embodiments, heterocycloalkenyl groups are bicyclic fused moieties. Exemplary heterocycloalkenyl groups include, without limitation, 7-oxabicyclo[2.2.1]hept-2-ene, 7-azabicyclo[2.2.1]hept-2-ene, and 7-methyl-7-azabicyclo[2.2.1]hept-2-ene.

Exemplary 3-membered heterocyclyl groups containing 1 heteroatom include, without limitation, aziridinyl, oxiranyl, and thiiranyl. Exemplary 4-membered heterocyclyl groups containing 1 heteroatom include, without limitation, azetidinyl, oxetanyl, and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered non-aromatic heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

In some embodiments, the term “heterocyclyl” refers to a radical of a 5-16 membered monocyclic or polycyclic (e.g., bicyclic, tricyclic) 4n+2 aromatic ring system (e.g., having 6, 10, or 14 π electrons shared in a cyclic array), also referred to as “heteroaryl”, having ring carbon atoms and 1-4 ring heteroatoms provided in the aromatic ring system, wherein each heteroatom is independently selected from nitrogen, oxygen, sulfur. In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-12 membered aromatic ring system having ring carbon atoms and 1-4 ring heteroatoms provided in the aromatic ring system, wherein each heteroatom is independently selected from nitrogen, oxygen, and sulfur (“5-12 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl, and phenazinyl.

The term “unsaturated” or “partially unsaturated” refers to a moiety that includes at least one double or triple bond.

The term “saturated” refers to a moiety that does not contain a double or triple bond, i.e., the moiety only contains single bonds.

Affixing the suffix “-ene” to a group indicates the group is a divalent moiety, e.g., alkylene is the divalent moiety of alkyl, arylene is the divalent moiety of aryl, heteroarylene is the divalent moiety of heteroaryl, cycloalkylene is a divalent moiety of cycloalkyl, and heterocyclylene is the divalent moiety of hereocyclyl.

The term “C_{x-y}” when used in conjunction with a chemical moiety, such as, acyl, acyloxy, alkyl, alkenyl, alkynyl, or alkoxy is meant to include groups that contain from x to y carbons in the chain. For example, the term “C_{x-y}alkyl” refers to substituted or unsubstituted saturated hydrocarbon groups, including straight-chain alkyl and branched-chain alkyl groups that contain from x to y carbons in the chain, including haloalkyl groups such as trifluoromethyl and 2,2,2-trifluoroethyl, etc. C₀ alkyl indicates a hydrogen where the group is in a terminal position, a bond if internal.

A group is optionally substituted unless expressly provided otherwise. The term “optionally substituted” refers to being substituted or unsubstituted. In certain embodiments, alkyl, cycloalkyl, cycloalkenyl, heterocyclyl, heterocycloalkenyl, aryl, and heteroaryl groups and the corresponding divalent moieties are optionally substituted. “Optionally substituted” refers to a group which may be substituted or unsubstituted (e.g., “substituted” or “unsubstituted” alkyl, “substituted” or “unsubstituted” cycloalkyl, “substituted” or “unsubstituted” cycloalkenyl, “substituted” or “unsubstituted” heterocyclyl, “substituted” or “unsubstituted” heterocycloalkenyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

Exemplary carbon atom substituents include, but are not limited to, halogen, —CN, —NO₂, —N₃, —OH, F, Cl, Br, I, oxo, —SO₂H, —SO₃H, —OR^{aa}, —NH(R^{aa})₂, —N(R^{aa})₂, —N(R^{aa})₃⁺X⁺, —SH, —SR^{aa}, —C(═O)R^{aa}, —CO₂H, —CHO, —CO₂R^{aa}, —OC(═O)R^{aa}, —OCO₂R^{aa}, —C(═O)N(R^{aa})₂, —OC(═O)N(R^{aa})₂, —NR^{aa}C(═O)R^{aa}, —NR^{aa}CO₂R^{aa}, —NR^{aa}C(═O)N(R^{aa})₂, —C(═NR^{aa})R^{aa}, —C(═O)NR^{aa}SO₂R^{aa}, —NR^{aa}SO₂R^{aa}, —SO₂N(R^{aa})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, C₁₋₁₂ alkyl, C₁₋₁₂ haloalkyl, 3-16 membered heterocyclyl, and C₆₋₁₂ aryl, wherein X is a counterion and each instance of R^{aa} is, independently, selected from H, —OH, C₁₋₁₀ alkyl, C₁₋₁₀ haloalkyl, C₃₋₁₂ cycloalkyl, 5-16 membered heterocyclyl, and C₆₋₁₂ aryl, or two R^{aa} groups are joined to form a 3-16 membered heterocyclyl.

Numeric ranges are inclusive of the numbers defining the range. Measured and measureable values are understood to be approximate, taking into account significant digits and the error associated with the measurement. As used in this application, the terms “about” and “approximately” have their art-understood meanings; use of one vs the other does not necessarily imply different scope. Unless otherwise indicated, numerals used in this application, with or without a modifying term such as “about” or “approximately”, should be understood to encompass normal divergence and/or fluctuations as would be appreciated by one of ordinary skill in the relevant art. In certain embodiments, the term “approximately” or “about” refers to a range of values that fall within 10%, 9%, 8%, 7%, 6%, 5%, 4%, 3%, 2%, 1%, or less in either direction (greater than or less than) of a stated reference value unless otherwise stated or otherwise evident from the context (except where such number would exceed 100% of a possible value).

Disclosed herein are catalyst/ionomer compositions prepared from ionomers comprising Tetrakis® cations. The term Tetrakis® refers to a cation of the following structural formula:

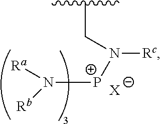

wherein [symbol] is a point of attachment to the polymer or to a linker connected to the polymer, and R^{a}, R^{b}, and R^{c} each independently is an alkyl or a cycloalkyl.

As used herein, the “main chain” of a polymer, or the “backbone” of the polymer, is the series of bonded atoms that together create the continuous chain of the polymer molecule. As used herein, a “side chain” of a polymer is the series of bonded atoms which are pendent from the main chain of a polymer.

As used herein, the term “repeat unit” (also known as a monomer unit) refers to a chemical moiety which appears multiple times in the main chain of the polymer to produce the complete polymer chain (except for the end-groups) by linking the repeat units together successively. A repeat unit is usually shown in square brackets with open valencies designating the points of attachment to the adjacent repeat units in the main chain:

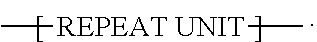

A polymer can contain one or more types of repeat units having different chemical structures. A polymer containing two or more different types of repeat units is known as a copolymer. A copolymer can be a block copolymer, where repeat units of the first type form a continuous main chain, i.e., a first homopolymer subunit, and repeat units of the second type form a continuous main chain, i.e., a second homopolymer subunit, and so forth for the required number of homopolymer subunits. The various homopolymer subunits are connected via covalent bonds to form the block copolymer. In some embodiments, the ionomers of the present disclosure are block copolymers.

A copolymer can be a statistical copolymer, also known as a random copolymer, where repeat units of different types are distributed randomly along the main chain. In random copolymers repeat units of the same type do not have to be attached to each other in the main chain. In some embodiments, the ionomers of the present disclosure are random copolymers.

As used herein, the term “cross-linked polymer” refers to a polymer in which two or more non-adjacent repeat units of the same main chain or two or more repeat units in different main chains are connected via a cross-linking moiety. The term “cross-linked polymer” also refers to two or more different main chains connected via a plurality of cross-linking moieties. For example, a cross-linked polymer, such as a cross-linked ionomer, can comprise a plurality of main chains connected by a plurality of cross-linking moieties to form an interconnected polymer network.

As used herein, the term “cross-linking moiety” refers to a polyvalent, for example, divalent or trivalent, moiety which forms covalent bonds with two or more non-adjacent repeat units of the same polymer main chain or with one or more repeat units of different main chains.

As used herein, the term “radical initiator” refers to a compound that can produce radical species and promote radical chain reactions, such as radical polymerizations. Examples of radical initiators include azo compounds and organic peroxides, such as 2,2′-azobis(2-methylpropionitrile), azobisisobutyronitrile, azobisdimethylvaleronitrile, and benzoyl peroxide.

As used herein, the phrase “catalyst is supported on carbon” refers to a catalyst-containing material in which the catalyst particles are deposited on the surface of activated carbon. Carbon as a support material for catalysts allows the dispersion and stabilization of small metal particles on a surface.

As used herein, the term “Raney nickel” refers a solid catalyst composed of fine grains of a nickel-aluminum alloy. A typical catalyst is around 85-percent nickel by mass, corresponding to about two atoms of nickel for every atom of aluminum.

The phrase “number average molecular weight” refers to total weight of polymer divided by the total number of molecules. The number average molecular weight is the common average of the molecular weights of the individual polymer molecules. It is determined by measuring the molecular weight of n polymer molecules, summing the weights, and dividing by n.

The term “current collector”, as used herein, refers to the electrical conductor between the electrode and external circuits in an electrochemical device such as a battery cell.

In a first example embodiment, the present disclosure relates to a membrane electrode assembly (MEA), comprising:
a support, and
a catalyst/ionomer layer, said catalyst/ionomer layer comprising a first cross-linked ionomer and a catalyst, wherein the first cross-linked ionomer comprises:
a plurality of first repeat units, wherein each first repeat unit is a moiety represented by a structural formula

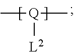

a plurality of second repeat units, wherein each second repeat unit is a moiety represented by a structural formula

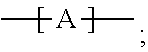

and a plurality of cross-linking moieties, wherein each cross-linking moiety is represented by structural formula (I) or (II):

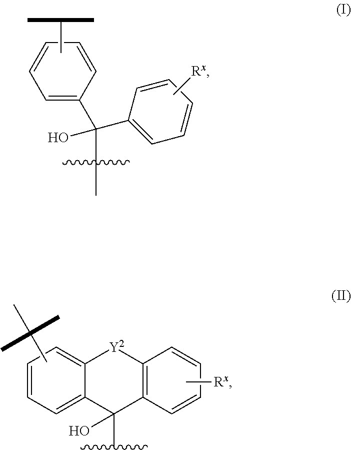

wherein, for each occurrence of the cross-linking moiety, the symbol [symbol] represents a point of attachment to L² and the symbol [symbol] represents a point of attachment to a first repeat unit or a second repeat unit;
and further wherein:

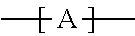

is a moiety represented by the following structural formula:

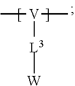

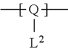

is a moiety represented by one of the following structural formulas:

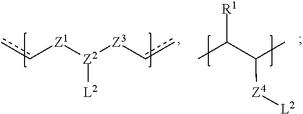

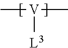

is a moiety represented by one of the following structural formulas:

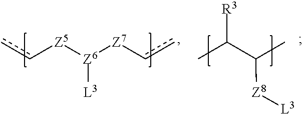

W is C₁₋₁₂ alkyl or a moiety represented by one of the structural formulas selected from:

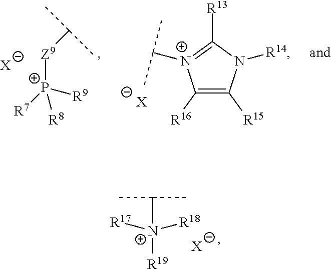

wherein:
the symbol [symbol] represents a point of attachment to L³, and the symbol [symbol] represents a double bond or a single bond;
Z¹, Z³, Z⁵, and Z⁷ each independently is a C₁₋₃ alkylene or a bond;
R¹ is selected from H, a C₁₋₁₂ alkyl, and C₆₋₁₂ aryl, and
Z⁴ is a bond or a C₆₋₁₂ arylene, or
Z⁴ is CH, and R¹ and Z⁴ together with the C₂ alkylene to which they are attached form a C₅₋₁₂ cycloalkyl or a 5 to 12-membered heterocyclyl; and
Z⁶ is selected from —CHR⁶—, a C₅₋₁₂ cycloalkylene, and a 5 to 16-membered heterocyclylene;
R³ is selected from H, a C₁₋₁₂ alkyl, and C₆₋₁₂ aryl, and
Z⁸ is a bond or a C₆₋₁₂ arylene, and CH, or
Z⁸ is CH, and R³ and Z⁸ together with the C₂ alkylene to which they are attached form a C₅₋₁₂ cycloalkyl or a 5 to 12-membered heterocyclyl; and
Z⁹ is NR¹⁰ or a bond;
R⁵ and R⁶ each independently is H or a C₁₋₁₂ alkyl;
R⁷, R⁸, and R⁹ each independently is selected from NR¹¹R¹², a C₆₋₁₂ aryl, and 5 to 12-membered heterocyclyl;
R¹⁰ is a C₁₋₁₂ alkyl;
R¹¹ and R¹² each independently is C₁₋₁₂ alkyl or a C₃₋₁₂ cycloalkyl, or R¹¹ and R¹² together with the nitrogen atom to which they are attached form a 5 to 12-membered heterocyclyl;
R¹³ is selected from a C₁₋₁₂ alkyl, C₆₋₁₂ aryl, and 5 to 12-membered heterocyclyl;
R¹⁴ is a C₁₋₁₂ alkyl or a C₃₋₁₂ cycloalkyl;
R¹⁵ and R¹⁶ each independently is selected from C₁₋₁₂ alkyl, C₆₋₁₂ aryl, and 5 to 12-membered heterocyclyl; or R¹⁵ and R¹⁶ together with the carbon atoms to which they are attached form a C₆₋₁₂ aryl or a 5 to 12-membered heterocyclyl; and
R¹⁷, R¹⁸, and R¹⁹ each independently is a C₁₋₁₂ alkyl or a C₃₋₁₂ cycloalkyl; or
R¹⁸ and R¹⁹ together with the nitrogen atom to which they are attached form a 5 to 12-membered heterocyclyl and (i) R¹⁷ is a C₁₋₁₂ alkyl or a C₃₋₁₂ cycloalkyl, or (ii) R¹⁷ and at least one atom of L³ together with the nitrogen atom to which L³ and R¹⁷ are attached form a 5- to 12-membered heterocyclyl; or
R¹⁷, R¹⁸, and R¹⁹ together with the nitrogen atom to which they are attached form a bicyclic 5 to 12-membered heterocyclyl; and
R^{x} is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl;
L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ;
L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond;
m is an integer between 1 and 6;
n is an integer between 1 and 6;
Y² is selected from —C(O)—, —O—, —S—, —NH—, —N(C₁₋₁₂ alkyl)-, and a bond;
X⁻ is selected from F⁻, Cl⁻, Br⁻, OH⁻, NO⁻₂, CN⁻, HCO₃⁻, CO₃²⁻, PF₆⁻, BF₄⁻, and a C₁₋₁₂ carboxylate;
provided that W is C₁₋₁₂ alkyl only when V is a cationic moiety,
and wherein:
each C₁₋₁₂ alkylene, C₆₋₁₂ arylene, C₅₋₁₂ cycloalkylene, 5 to 16-membered heterocyclylene, C₁₋₁₂alkyl, C₃₋₁₂cycloalkyl, C₅₋₁₂cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

In a first aspect of the first embodiment,

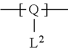

is a moiety represented by the following structural formula:

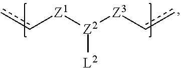

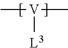

is a moiety represented by the following structural formula:

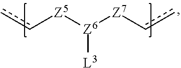

W is a C₁₋₁₂ alkyl or a moiety represented by the following structural formula:

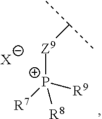

and
each cross-linking moiety is represented by structural formula (I).

In a second aspect of the first embodiment,

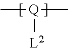

is a moiety represented by the following structural formula:

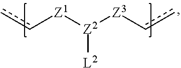

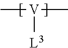

is a moiety represented by the following structural formula:

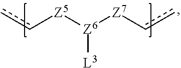

W is a C₁₋₁₂ alkyl or a moiety represented by the following structural formula:

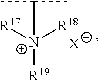

and
each cross-linking moiety is represented by structural formula (I). The remainder of features and example features of the second aspect is as described above with respect to the first aspect of the first embodiment.

In a third aspect of the first embodiment,

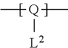

is a moiety represented by the following structural formula:

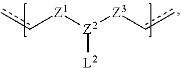

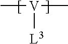

is a moiety represented by the following structural formula:

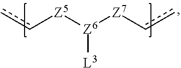

W is a C₁₋₁₂ alkyl or a moiety represented by the following structural formula:

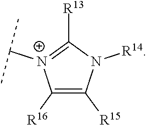

and each cross-linking moiety is represented by structural formula (I). The remainder of features and example features of the third aspect is as described above with respect to the first and second aspects of the first embodiment.

In a fourth aspect of the first embodiment,

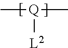

is a moiety represented by the following structural formula:

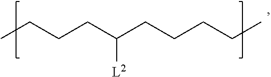

is a moiety represented by the following structural formula:

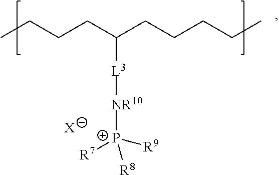

each third repeat unit is a C₈ alkylene, and each cross-linking moiety is represented by structural formula (I). The remainder of features and example features of the fourth aspect is as described above with respect to the first through third aspects of the first embodiment.

In a fifth aspect of the first embodiment,

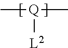

is a moiety represented by the following structural formula:

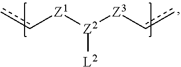

The remainder of features and example features of the fifth aspect is as described above with respect to the first through fourth aspects of the first embodiment.

In a sixth aspect of the first embodiment,

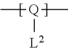

is a moiety represented by the following structural formula:

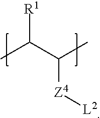

The remainder of features and example features of the sixth aspect is as described above with respect to the first through fifth aspects of the first embodiment.

In a seventh aspect of the first embodiment,

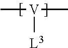

is a moiety represented by the following structural formula:

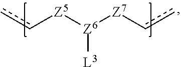

The remainder of features and example features of the seventh aspect is as described above with respect to the first through sixth aspects of the first embodiment.

In an eighth aspect of the first embodiment

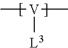

is a moiety represented by the following structural formula:

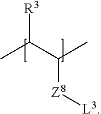

The remainder of features and example features of the eighth aspect is as described above with respect to the first through seventh aspects of the first embodiment.

In a ninth aspect of the first embodiment, the first cross-linked ionomer further comprises a plurality of third repeat units, wherein each third repeat unit is a moiety represented by the following structural formula:

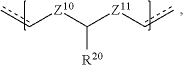

wherein
Z¹⁰ and Z¹¹ each independently is a C₁₋₃ alkylene or a bond;
R²⁰ is H, a C₁₋₁₂ alkyl, or a C₆₋₁₂ aryl.

In some instances, at least one third repeat unit is connected to the cross-linking moiety represented by structural formula (I) or (II) through the point of attachment on the cross-linking moiety designated as [symbol] .

In a tenth aspect of the first embodiment, the each first repeat unit is a moiety represented by the following structural formula:

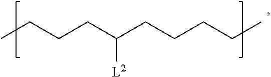

each second repeat unit is a moiety represented by the following structural formula:

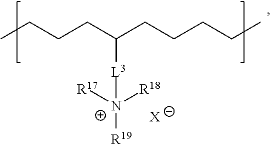

each third repeat unit is a C₈ alkylene, and each cross-linking moiety is represented by structural formula (I). The remainder of features and example features of the tenth aspect is as described above with respect to the first through ninth aspects of the first embodiment.

In an eleventh aspect of the first embodiment, each first repeat unit is a moiety represented by the following structural formula:

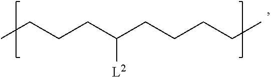

each second repeat unit is a moiety represented by the following structural formula:

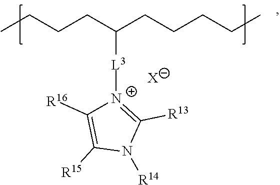

each third repeat unit is a C₈ alkylene, and each cross-linking moiety is represented by structural formula (I). For example, R¹³, R¹⁴, R¹⁵, and R¹⁶ are methyl, and the molar ratio of the first repeat units, second repeat units, and third repeat units is 1:14:5. The remainder of features and example features of the eleventh aspect is as described above with respect to the first through tenth aspects of the first embodiment.

In a twelfth aspect of the first embodiment,

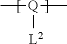

is a moiety represented by any one of the following structural formulas:

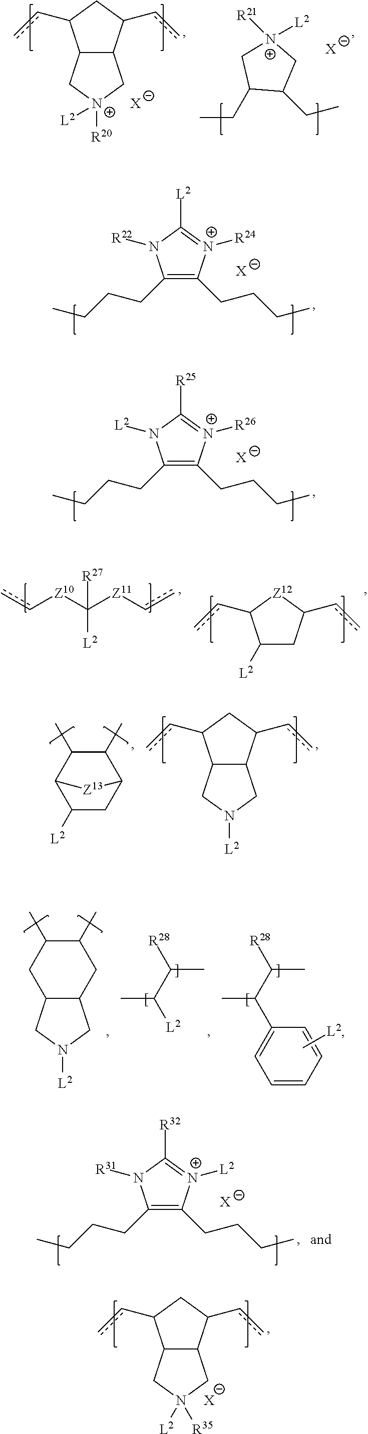

wherein:
R²⁰, R²², R²⁴, R²⁶, and R³¹ each independently is a C₁₋₁₂ alkyl;
R²¹ is a C₁₋₁₂ alkyl, or R²¹ together with the nitrogen atom to which it is attached and at least one atom of L² form a 5- to 12-membered heterocyclyl
R²⁵ and R³² each independently is a C₆₋₁₂ aryl;
R²⁷ is H or a C₁₋₁₂ alkyl;
R²⁸ is H, a C₁₋₁₂ alkyl, or a C₆₋₁₂ aryl;
R³⁵ is a C₁₋₁₂ alkyl, or R³⁵ together with the nitrogen atom to which it is attached and at least one atom of L² form a 5- to 12-membered heterocyclyl;
Z¹⁰ and Z¹¹ each independently is a C₁₋₃ alkylene or a bond; and
Z¹² and Z¹³ each independently is selected from CH₂, O, NH, and N(C₁₋₁₂ alkyl). The remainder of features and example features of the twelfth aspect is as described above with respect to the first through eleventh aspects of the first embodiment.

In a thirteenth aspect of the first embodiment,

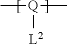

is a moiety represented by any one of the following structural formulas:

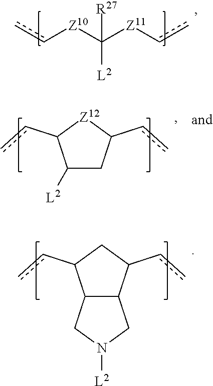

The remainder of features and example features of the thirteenth aspect is as described above with respect to the first through twelfth aspects of the first embodiment.

In a fourteenth aspect of the first embodiment,

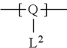

is a moiety represented by the following structural formula:

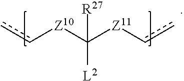

For example,

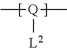

is a moiety represented by the following structural formula:

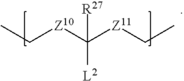

### Alternatively,

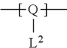

is a moiety represented by the following structural formula:

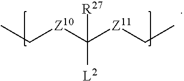

The remainder of features and example features of the fourteenth aspect is as described above with respect to the first through thirteenth aspects of the first embodiment.

In a fifteenth aspect of the first embodiment, Z¹⁰ and Z¹¹ each independently is a C₁₋₃ alkylene. For example, Z¹⁰ is C₂ alkylene and Z¹¹ is C₃ alkylene. The remainder of features and example features of the fifteenth aspect is as described above with respect to the first through fourteenth aspects of the first embodiment.

In a sixteenth aspect of the first embodiment, R²⁷ is H or methyl. The remainder of features and example features of the sixteenth aspect is as described above with respect to the first through fifteenth aspects of the first embodiment.

In a seventeenth aspect of the first embodiment,

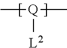

is a moiety represented by the following structural formula:

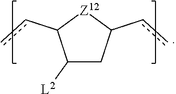

For example,

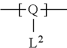

is a moiety represented by the following structural formula:

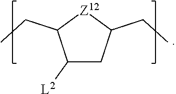

### Alternatively,

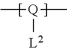

is a moiety represented by the following structural formula:

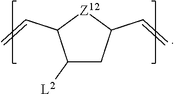

The remainder of features and example features of the seventeenth aspect is as described above with respect to the first through sixteenth aspects of the first embodiment.

In an eighteenth aspect of the first embodiment, Z¹² is CH₂, O, NH or N(C₁₋₁₂ alkyl). For example, Z¹² is CH₂ or O. Alternatively, Z¹² is NH or N(C₁₋₁₂ alkyl). The remainder of features and example features of the eighteenth aspect is as described above with respect to the first through seventeenth aspects of the first embodiment.

In a nineteenth aspect of the first embodiment,

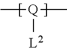

is a moiety represented by any one of the following structural formulas:

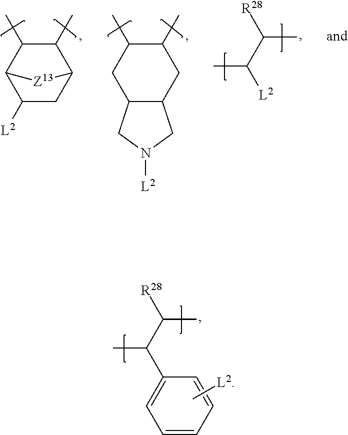

The remainder of features and example features of the nineteenth aspect is as described above with respect to the first through eighteenth aspects of the first embodiment.

In a twentieth aspect of the first embodiment,

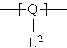

is a moiety represented by the following structural formula:

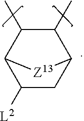

The remainder of features and example features of the twentieth aspect is as described above with respect to the first through nineteenth aspects of the first embodiment.

In a twenty-first aspect of the first embodiment, Z¹³ is CH₂, O, NH, or N(C₁₋₁₂ alkyl). For example, Z¹³ is CH₂ or O. Alternatively, Z¹³ is NH or N(C₁₋₁₂ alkyl). The remainder of features and example features of the twenty-first aspect is as described above with respect to the first through twentieth aspects of the first embodiment.

In a twenty-second aspect of the first embodiment

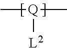

is a moiety represented by the following structural formula:

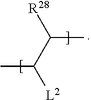

The remainder of features and example features of the twenty-second aspect is as described above with respect to the first through twenty-first aspects of the first embodiment.

In a twenty-third aspect of the first embodiment, R²⁸ is H or methyl. For example, R²⁸ is H. Alternatively, R²⁸ is methyl. The remainder of features and example features of the twenty-third aspect is as described above with respect to the first through twenty-second aspects of the first embodiment.

In a twenty-fourth aspect of the first embodiment,

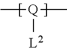

is a moiety represented by the following structural formula:

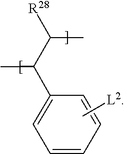

The remainder of features and example features of the twenty-fourth aspect is as described above with respect to the first through twenty-third aspects of the first embodiment.

In a twenty-fifth aspect of the first embodiment,

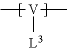

is a moiety represented by any one of the following structural formulas:

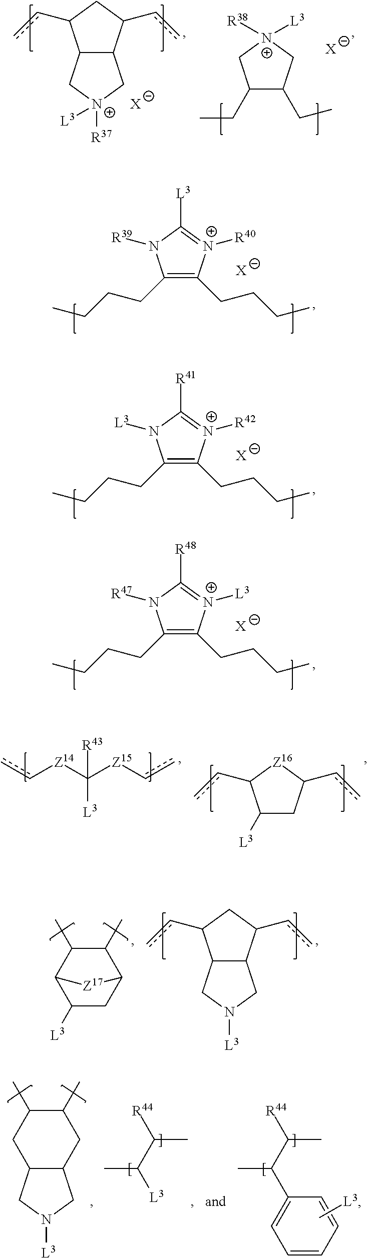

wherein:
R³⁹, R⁴⁰, R⁴², R⁴⁵, R⁴⁷, and R⁴⁹ each independently is a C₁₋₁₂ alkyl;
R⁴¹ and R⁴⁸ each independently is a C₆₋₁₂ aryl;
R⁴³ is H or a C₁₋₁₂ alkyl;
R⁴⁴ is H, a C₁₋₁₂ alkyl, or a C₆₋₁₂ aryl;
R³⁷ is a C₁₋₁₂ alkyl, or R³⁷ together with the nitrogen atom to which it is attached and at least one atom of L³ form a 5- to 12-membered heterocyclyl;
R³⁸ is a C₁₋₁₂ alkyl, or R³⁸ together with the nitrogen atom to which it is attached and at least one atom of L³ form a 5- to 12-membered heterocyclyl;
Z¹⁴ and Z¹⁵ each independently is a C₁₋₃ alkylene or a bond; and
Z¹⁶ and Z¹⁷ each independently is selected from CH₂, O, NH, and N(C₁₋₁₂ alkyl). The remainder of features and example features of the twenty-fifth aspect is as described above with respect to the first through twenty-fourth aspects of the first embodiment.

In a twenty-sixth aspect of the first embodiment,

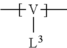

is a moiety represented by any one of the following structural formulas:

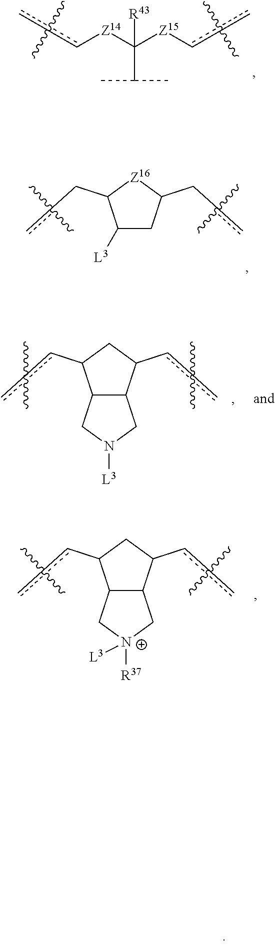

The remainder of features and example features of the twenty-sixth aspect is as described above with respect to the first through twenty-fifth aspects of the first embodiment.

In a twenty-seventh aspect of the first embodiment,

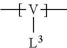

is a moiety represented by the following structural formula:

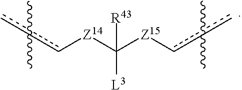

For example,

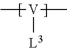

is a moiety represented by the following structural formula:

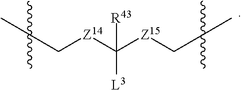

### Alternatively,

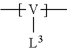

is a moiety represented by the following structural formula:

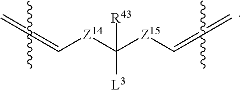

The remainder of features and example features of the twenty-seventh aspect is as described above with respect to the first through twenty-sixth aspects of the first embodiment.

In a twenty-eighth aspect of the first embodiment, Z¹⁴ and Z¹⁵ each independently is a C₁₋₃ alkylene. For example, Z¹⁴ is C₂ alkylene and Z¹⁵ is C₃ alkylene. The remainder of features and example features of the twenty-eighth aspect is as described above with respect to the first through twenty-seventh aspects of the first embodiment.

In a twenty-ninth aspect of the first embodiment, R⁴³ is H or methyl. For example, R⁴³ is H. Alternatively, R⁴³ is methyl. The remainder of features and example features of the twenty-ninth aspect is as described above with respect to the first through twenty-eighth aspects of the first embodiment.

In a thirtieth aspect of the first embodiment,

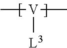

is a moiety represented by the following structural formula:

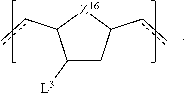

For example,

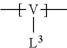

is a moiety represented by the following structural formula:

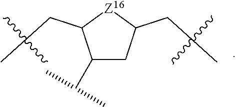

### Alternatively,

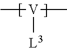

is a moiety represented by the following structural formula:

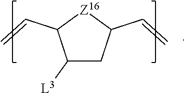

The remainder of features and example features of the thirtieth aspect is as described above with respect to the first through twenty-ninth aspects of the first embodiment.

In a thirty-first aspect of the first embodiment, Z¹⁶ is CH₂, O, NH or N(C₁₋₁₂ alkyl). For example, Z¹⁶ is CH₂ or O. Alternatively, Z¹⁶ is NH or N(C₁₋₁₂ alkyl). The remainder of features and example features of the thirty-first aspect is as described above with respect to the first through thirtieth aspects of the first embodiment.

In a thirty-second aspect of the first embodiment,

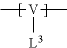

is a moiety represented by any one of the following structural formulas:

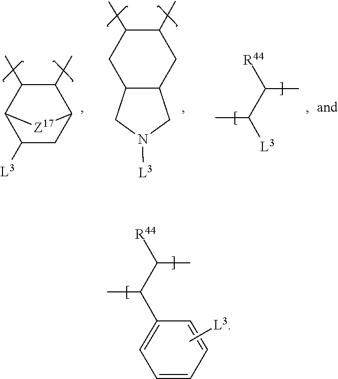

The remainder of features and example features of the thirty-second aspect is as described above with respect to the first through thirty-first aspects of the first embodiment.

In a thirty-third aspect of the first embodiment,

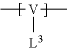

is a moiety represented by the following structural formula:

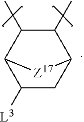

The remainder of features and example features of the thirty-third aspect is as described above with respect to the first through thirty-second aspects of the first embodiment.

In a thirty-fourth aspect of the first embodiment, Z¹³ is CH₂, O, NH or N(C₁₋₁₂ alkyl). For example, Z¹³ is CH₂ or O. Alternatively, Z¹³ is NH or N(C₁₋₁₂ alkyl). The remainder of features and example features of the thirty-fourth aspect is as described above with respect to the first through thirty-third aspects of the first embodiment.

In a thirty-fifth aspect of the first embodiment,

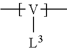

is a moiety represented by the following structural formula:

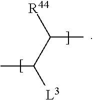

The remainder of features and example features of the thirty-fifth aspect is as described above with respect to the first through thirty-fourth aspects of the first embodiment.

In a thirty-sixth aspect of the first embodiment, R⁴⁴ is H or methyl. For example, R⁴⁴ is H. Alternatively, R⁴⁴ is methyl. The remainder of features and example features of the thirty-sixth aspect is as described above with respect to the first through thirty-fifth aspects of the first embodiment.

In a thirty-seventh aspect of the first embodiment,

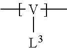

is a moiety represented by the following structural formula:

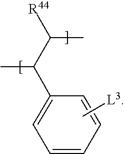

The remainder of features and example features of the thirty-seventh aspect is as described above with respect to the first through thirty-sixth aspects of the first embodiment.

In a thirty-eighth aspect of the first embodiment, W is

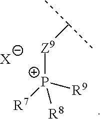

The remainder of features and example features of the thirty-eighth aspect is as described above with respect to the first through thirty-seventh aspects of the first embodiment.

In a thirty-ninth aspect of the first embodiment, Z⁹ is NR¹⁰; and R⁷, R⁸, and R⁹ each independently is NR¹¹R¹². The remainder of features and example features of the thirty-ninth aspect is as described above with respect to the first through thirty-eighth aspects of the first embodiment.

In a fortieth aspect of the first embodiment, Z⁹ is a bond and R⁷, R⁸, and R⁹ each independently is a C₆₋₁₂ aryl. For example, R⁷, R⁸, and R⁹ each is phenyl. The remainder of features and example features of the fortieth aspect is as described above with respect to the first through thirty-ninth aspects of the first embodiment.

In a forty-first aspect of the first embodiment, R¹¹ and R¹² each independently is C₁₋₁₂ alkyl or a C₃₋₁₂ cycloalkyl. For example, R¹¹ is a C₁₋₃ alkyl, and R¹² is a C₅₋₇ cycloalkyl or a C₁₋₃ alkyl. For example, R¹¹ and R¹² are each methyl; or R¹¹ is methyl and R¹² is isopropyl; or R¹¹ is cyclohexyl and R¹² is methyl. The remainder of features and example features of the forty-first aspect is as described above with respect to the first through fortieth aspects of the first embodiment.

In a forty-second aspect of the first embodiment, W is

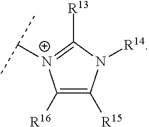

The remainder of features and example features of the forty-second aspect is as described above with respect to the first through forty-first aspects of the first embodiment.

In a forty-third aspect of the first embodiment, R¹³ is an unsubstituted C₆₋₁₂ aryl. For example, R¹³ is an unsubstituted phenyl. Alternatively, R¹³ is a C₆₋₁₂ aryl substituted with 1 to 3 substituents independently selected from a C₁₋₁₂ alkyl, C₁₋₁₂ alkoxy, and N(C₁₋₁₂ alkyl)₂. For example, R¹³ is a C₆₋₁₂ aryl substituted with 1 to 3 substituents independently selected from methyl, ethyl, propyl, isopropyl, methoxy, ethoxy, propoxy, isopropoxy, dimethylamino, or diethylamino, such as phenyl substituted with 1 to 3 substituents independently selected from methyl, ethyl, propyl, isopropyl, methoxy, ethoxy, propoxy, isopropoxy, dimethylamino, or diethylamino. The remainder of features and example features of the forty-third aspect is as described above with respect to the first through forty-second aspects of the first embodiment.

In a forty-fourth aspect of the first embodiment, R¹⁴ is a C₁₋₁₂ alkyl. For example, R¹⁴ is methyl, ethyl, propyl, isopropyl, butyl, sec-butyl, isobutyl, or tert-butyl. Alternatively, R¹⁴ is a C₃₋₈ cycloalkyl, such as cyclopropyl, cyclobutyl, cyclopentyl, or cyclohexyl. The remainder of features and example features of the forty-fourth aspect is as described above with respect to the first through forty-third aspects of the first embodiment.

In a forty-fifth aspect of the first embodiment, R¹⁵ and R¹⁶ each independently is a C₁₋₁₂ alkyl. For example, R¹⁵ and R¹⁶ each independently is methyl, ethyl, propyl, isopropyl, butyl, sec-butyl, isobutyl, or tert-butyl. For example, R¹⁵ and R¹⁶ each is methyl. The remainder of features and example features of the forty-fifth aspect is as described above with respect to the first through forty-fourth aspects of the first embodiment.

In a forty-sixth aspect of the first embodiment, R¹⁵ and R¹⁶ each independently is a C₆₋₁₂ aryl. For example, R¹⁵ and R¹⁶ are each phenyl. The remainder of features and example features of the forty-sixth aspect is as described above with respect to the first through forty-fifth aspects of the first embodiment.

In a forty-seventh aspect of the first embodiment, R¹⁵ and R¹⁶ together with the carbon atoms to which they are attached form a C₆₋₁₂ aryl. For example, R¹⁵ and R¹⁶ together with the carbon atoms to which they are attached form a C₆ aryl. The remainder of features and example features of the forty-seventh aspect is as described above with respect to the first through forty-sixth aspects of the first embodiment.

In a forty-eighth aspect of the first embodiment, W is

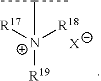

The remainder of features and example features of the forty-eighth aspect is as described above with respect to the first through forty-seventh aspects of the first embodiment.

In a forty-ninth aspect of the first embodiment, R¹⁷, R¹⁸, and R¹⁹ each independently is selected from a C₁₋₁₂ alkyl. For example, R¹⁷, R¹⁸, and R¹⁹ each is methyl. The remainder of features and example features of the forty-ninth aspect is as described above with respect to the first through forty-eighth aspects of the first embodiment.

In a fiftieth aspect of the first embodiment, R¹⁷ is a C₁₋₁₂ alkyl and R¹⁸, and R¹⁹ together with the nitrogen atom to which they are attached form a 5 to 12-membered heterocyclyl. The remainder of features and example features of the fiftieth aspect is as described above with respect to the first through forty-ninth aspects of the first embodiment.

In a fifty-first aspect of the first embodiment, R¹⁷, R¹⁸, and R¹⁹ together with the nitrogen atom to which they are attached form a bicyclic 5 to 12-membered heterocyclyl. The remainder of features and example features of the fifty-first aspect is as described above with respect to the first through fiftieth aspects of the first embodiment.

In a fifty-second aspect of the first embodiment, L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ. Each of the moieties representing L² can be attached to Q by either end of the moiety. For example, if L² is OC(O)(C₁₋₁₂ alkylene)ₘ, it can be attached to Q through the ester or through the alkylene. In some instances, L² is a C₁₋₁₂ alkylene. For example, L² is C₁ alkylene, C₂ alkylene, C₃ alkylene, C₄ alkylene, C₅ alkylene, C₆ alkylene, C₇ alkylene, C₈ alkylene, C₉ alkylene, C₁₀ alkylene, C₁₁ alkylene, or C₁₂ alkylene. The remainder of features and example features of the fifty-second aspect is as described above with respect to the first through fifty-first aspects of the first embodiment.

In a fifty-third aspect of the first embodiment, L² is (O—C₁₋₁₂ alkylene)ₘ or (C₁₋₁₂ alkylene-O)ₘ. For example, L² is —CH₂O— or —OCH₂—. The remainder of features and example features of the fifty-third aspect is as described above with respect to the first through fifty-second aspects of the first embodiment.

In a fifty-fourth aspect of the first embodiment, m is 1, 2, 3, 4, 5, or 6. For example, m is 1. The remainder of features and example features of the fifty-fourth aspect is as described above with respect to the first through fifty-third aspects of the first embodiment.

In a fifty-fifth aspect of the first embodiment, L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond. Each of the moieties representing L³ can be attached to Q by either end of the moiety. For example, if L³ is OC(O)(C₁₋₁₂ alkylene)ₙ, it can be attached to Q through the ester or through the alkylene. In some instances, L³ is a C₁₋₁₂ alkylene. For example, L³ is C₁ alkylene, C₂ alkylene, C₃ alkylene, C₄ alkylene, C₅ alkylene, C₆ alkylene, C₇ alkylene, C₈ alkylene, C₉ alkylene, C₁₀ alkylene, C₁₁ alkylene, or C₁₂ alkylene. For example, L³ is methylene. The remainder of features and example features of the fifty-fifth aspect is as described above with respect to the first through fifty-fourth aspects of the first embodiment.

In a fifty-sixth aspect of the first embodiment, L³ is (O—C₁₋₁₂ alkylene)ₙ or (C₁₋₁₂ alkylene-O)ₙ. For example, L³ is —CH₂O— or —OCH₂—. The remainder of features and example features of the fifty-sixth aspect is as described above with respect to the first through fifty-fifth aspects of the first embodiment.

In a fifty-seventh aspect of the first embodiment, n is 1, 2, 3, 4, 5, or 6. For example, n is 1. The remainder of features and example features of the fifty-seventh aspect is as described above with respect to the first through fifty-sixth aspects of the first embodiment.

In a fifty-eighth aspect of the first embodiment,

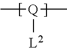

is a moiety represented by the following structural formula:

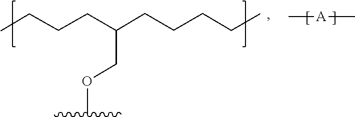

is a moiety represented by the following structural formula:

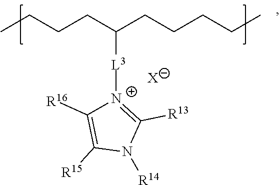

each third repeat unit is a C₈ alkylene, and each cross-linking moiety is represented by structural formula (I). The remainder of features and example features of the fifty-eighth aspect is as described above with respect to the first through fifty-seventh aspects of the first embodiment.

In a fifty-ninth aspect of the first embodiment,

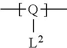

is a moiety represented by the following structural formula:

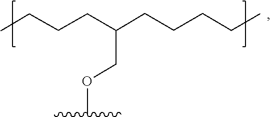

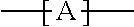

is a moiety represented by the following structural formula:

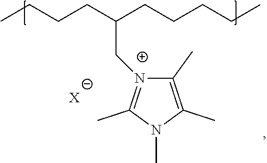

each third repeat unit is a C₈ alkylene, each cross-linking moiety is represented by structural formula (I), and the molar ratio of the first repeat units, second repeat units, and third repeat units is 1:14:5.

In a sixtieth aspect of the first embodiment, the first cross-linked ionomer comprises from about 0.5 mol-% to about 15 mol-% of the first repeat units. For example, the first cross-linked ionomer comprises from about 0.5 mol-% to about 15 mol-%, from about 1 mol-% to about 14 mol-%, from about 2 mol-% to about 12 mol-%, from about 3 mol-% to about 10 mol-%, from about 0.5 mol-% to about 10 mol-%, from about 0.5 mol-% to about 7 mol-%, from about 0.5 mol-% to about 10 mol-%, from about 0.5 mol-% to about 10 mol-%, from about 1 mol-% to about 10 mol-%, from about 1 mol-% to about 7 mol-%, from about 1 mol-% to about 5 mol-%, or from about 2 mol-% to about 7 mol-% of the first repeat units. For example, the first cross-linked ionomer comprises about 0.5 mol-%, about 1 mol-%, about 2 mol-%, about 3 mol-%, about 4 mol-%, about 5 mol-%, about 6 mol-%, about 7 mol-%, about 8 mol-%, about 9 mol-%, about 10 mol-%, about 11 mol-%, about 12 mol-% about 13 mol-%, about 14 mol-%, or about 15 mol-% of the first repeat units. For example, the first cross-linked ionomer comprises about 5 mol-% of the first repeat units. The remainder of features and example features of the sixtieth aspect is as described above with respect to the first through fifty-ninth aspects of the first embodiment.

In a sixty-first aspect of the first embodiment, the first cross-linked ionomer comprises from about 20 mol-% to about 98 mol-% of the second repeat units. For example, the first cross-linked ionomer comprises from about 20 mol-% to about 95 mol-%, from about 20 mol-% to about 90 mol-%, from about 20 mol-% to about 80 mol-%, from about 20 mol-% to about 70 mol-%, from about 20 mol-% to about 60 mol-%, from about 20 mol-% to about 50 mol-%, from about 30 mol-% to about 80 mol-%, from about 30 mol-% to about 70 mol-%, from about 40 mol-% to about 90 mol-%, from about 50 mol-% to about 90 mol-%, from about 50 mol-% to about 80 mol-%, or from about 60 mol-% to about 90 mol-% of the second repeat units. For example, the first cross-linked ionomer comprises about 20 mol-%, about 25 mol-%, about 30 mol-%, about 35 mol-%, about 40 mol-%, about 45 mol-%, about 50 mol-%, about 55 mol-%, about 60 mol-%, about 65 mol-%, about 70 mol-%, about 75 mol-%, about 80 mol-% about 85 mol-%, about 90 mol-%, or about 95 mol-% of the second repeat units. For example, the first cross-linked ionomer comprises about 70 mol-% of the second repeat units. The remainder of features and example features of the sixty-first aspect is as described above with respect to the first through sixtieth aspects of the first embodiment.

In a sixty-second aspect of the first embodiment, the first cross-linked ionomer comprises from about 0 mol-% to about 70 mol-% of the third repeat units. For example, the first cross-linked ionomer comprises from about 0 mol-% to about 60 mol-%, from about 0 mol-% to about 50 mol-%, from about 0 mol-% to about 40 mol-%, from about 0 mol-% to about 30 mol-%, from about 0 mol-% to about 20 mol-%, from about 0 mol-% to about 10 mol-%, from about 50 mol-% to about 70 mol-%, from about 5 mol-% to about 50 mol-%, from about 5 mol-% to about 40 mol-%, from about 10 mol-% to about 80 mol-%, from about 10 mol-% to about 50 mol-%, or from about 10 mol-% to about 40 mol-% of the third repeat units. For example, the first cross-linked ionomer comprises about 0 mol-%, about 5 mol-%, about 10 mol-%, about 15 mol-%, about 20 mol-%, about 25 mol-%, about 530 mol-%, about 35 mol-%, about 40 mol-%, about 45 mol-%, about 50 mol-%, about 55 mol-%, about 60 mol-% about 65 mol-%, or about 90 mol-% of the third repeat units. For example, the first cross-linked ionomer comprises about 25 mol-% of the third repeat units.

The remainder of features and example features of the sixty-second aspect is as described above with respect to the first through sixty-first aspects of the first embodiment.

In a sixty-third aspect of the first embodiment,

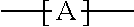

is a moiety represented by the following structural formula:

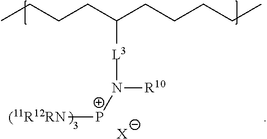

For example,

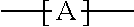

is a moiety represented by the following structural formula:

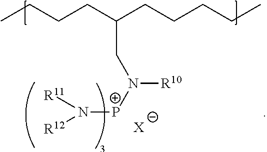

The remainder of features and example features of the sixty-third aspect is as described above with respect to the first through sixty-second aspects of the first embodiment.

In a sixty-fourth aspect of the first embodiment,

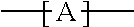

is a moiety represented by the following structural formula:

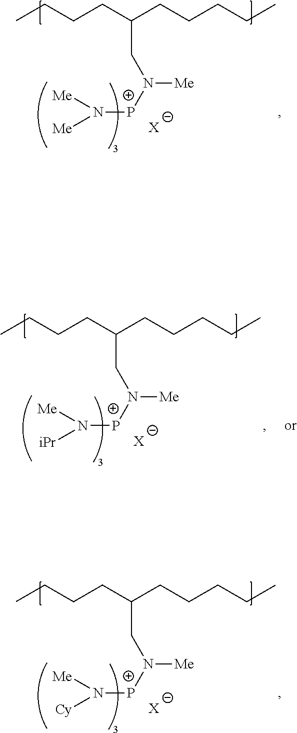

wherein Me is methyl, iPr is isopropyl and Cy is cyclohexyl. The remainder of features and example features of the sixty-fourth aspect is as described above with respect to the first through sixty-third aspects of the first embodiment.

In a sixty-fifth aspect of the first embodiment, each cross-linking moiety is represented by structural formula (I). The remainder of features and example features of the sixty-fifth aspect is as described above with respect to the first through sixty-fourth aspects of the first embodiment.

In a sixty-sixth aspect of the first embodiment, the number average molecular weight (MWn) of the first cross-linked ionomer is from about 30,000 g/mol to about 500,000 g/mol. For example, the MWn of the first cross-linked ionomer is from about 50,000 g/mol to about 360,000 g/mol. The remainder of features and example features of the sixty-sixth aspect is as described above with respect to the first through sixty-fifth aspects of the first embodiment.

In a sixty-seventh aspect of the first embodiment, the ionomer comprises from about 10 mol-% to about 80 mol-% of the second repeat units. For example, the first cross-linked ionomer comprises from about 20 mol-% to about 60 mol-% of the second repeat units, such as about 28 mol-%, about 46 mol-%, or about 70 mol-%. The remainder of features and example features of the sixty-seventh aspect is as described above with respect to the first through sixty-sixth aspects of the first embodiment.

In a sixty-eighth aspect of the first embodiment, the number average molecular weight (MWn) of the first cross-linked ionomer is from about 30,000 g/mol to about 500,000 g/mol. For example, the MWn of the first cross-linked ionomer is from about 50,000 g/mol to about 360,000 g/mol. The remainder of features and example features of the sixty-eighth aspect is as described above with respect to the first through sixty-seventh aspects of the first embodiment. The remainder of features and example features of the sixty-eighth aspect is as described above with respect to the first through sixty-seventh aspects of the first embodiment.

In a sixty-ninth aspect of the first embodiment, the catalyst is dispersed within the first cross-linked ionomer. For example, the particles of the catalyst are evenly distributed throughout the cross-linked ionomer layer. The remainder of features and example features of the sixty-ninth aspect is as described above with respect to the first through sixty-eighth aspects of the first embodiment.

In a seventieth aspect of the first embodiment, the catalyst comprises:
i) a metal selected from Ni, Fe, Ru, Ir, Co, Mn, Pt, Pd, Mo, and, La, or a combination thereof; and/or (ii) an oxide of a metal selected from Ni, Fe, Ru, Ir, Co, Mn, Pt, Pd, Mo, and La, or a combination thereof. For example, the catalyst comprises a metal selected from Ni, Fe, Ru, Ir, Co, Mn, Pt, Pd, Mo, and, La, or a combination thereof. For example, the catalyst comprises an oxide of a metal selected from Ni, Fe, Ru, Ir, Co, Mn, Pt, Pd, Mo, and La, or a combination thereof. In some embodiments of the seventieth aspect, the catalyst is supported on carbon. In some embodiments of the seventieth aspect, the catalyst is selected from Pt, Pt supported on carbon (Pt/C), Pt and Ru supported on carbon (PtRu/C), Pd, Pd supported on carbon (Pd/C), Ir, IrO₂, IrRuO, RuO₂, Raney nickel (Al/Ni), Ni_{0.5}Co_{0.5}Fe₂O₄, NiCoO₂, NiFe, NiFe₂O₄, NiO, NiMo, Ni and Mo supported on carbon (NiMo/C), FeCoNi, Fe₂O₃, LaCoO₃, LiNiO₂, LiCoO₂, Co₃O₄, CoFe₂O₄, CoO, MnO, Mn₂O₃, MnO₂, and Mn₃O₄, or a combination thereof. For example, the catalyst is selected from Pt, Pt/C, Ir, IrO₂, IrRuO, RuO₂, Ni_{0.5}Co_{0.5}Fe₂O₄, and NiCoO₂, or a combination thereof. For example, the catalyst is Ni_{0.5}Co_{0.5}Fe₂O₄ or NiFe₂O₄. In some embodiments of the seventieth aspect, the catalyst is selected Raney nickel (Al/Ni), Ni_{0.5}Co_{0.5}Fe₂O₄, NiCoO₂, NiFe, NiFe₂O₄, NiO, NiMo, Ni and Mo supported on carbon (NiMo/C), FeCoNi, Fe₂O₃, LaCoO₃, LiNiO₂, LiCoO₂, Co₃O₄, CoFe₂O₄, CoO, MnO, Mn₂O₃, MnO₂, and Mn₃O₄. The remainder of features and example features of the seventieth aspect is as described above with respect to the first through sixty-ninth aspects of the first embodiment.

In a seventy-first aspect of the first embodiment, the catalyst/ionomer layer comprises about 50-97 wt. % catalyst and about 3-50 wt. % ionomer. For example, the catalyst/ionomer layer comprises about 50-95 wt. % catalyst and about 5-50 wt. % ionomer, about 60-95 wt. % catalyst and about 5-40 wt. % ionomer, about 70-95 wt. % catalyst and about 5-30 wt. % ionomer, about 60-90 wt. % catalyst and about 10-40 wt. % ionomer, about 65-90 wt. % catalyst and about 10-35 wt. % ionomer, about 70-90 wt. % catalyst and about 10-30 wt. % ionomer, about 75-90 wt. % catalyst and about 10-25 wt. % ionomer, about 65-95 wt. % catalyst and about 5-35 wt. % ionomer, about 70-95 wt. % catalyst and about 5-30 wt. % ionomer, about 75-95 wt. % catalyst and about 5-25 wt. % ionomer, about 65-85 wt. % catalyst and about 15-35 wt. % ionomer, about 65-80 wt. % catalyst and about 20-35 wt. % ionomer. For example, the catalyst/ionomer layer comprises about 80-90 wt. % catalyst and about 10-20 wt. % ionomer. The remainder of features and example features of the seventy-first aspect is as described above with respect to the first through seventieth aspects of the first embodiment.

In a seventy-second aspect of the first embodiment, the catalyst/ionomer layer is disposed on a support. The remainder of features and example features of the seventy-second aspect is as described above with respect to the first through seventy-first aspects of the first embodiment.

In a seventy-third aspect of the first embodiment, the support is an alkaline exchange membrane (AEM), said AEM comprising a second ionomer. The remainder of features and example features of the seventy-third aspect is as described above with respect to the first through seventy-second aspects of the first embodiment.

In a seventy-fourth aspect of the first embodiment, the second ionomer is a second cross-linked ionomer comprising:
a plurality of first repeat units, wherein each first repeat unit is a moiety represented by structural formula

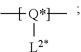

a plurality of second repeat units, wherein each second repeat unit is a moiety represented by structural formula

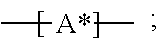

and a plurality of cross-linking moieties, wherein each crosslinking moiety is represented by structural formula (III) or (IV):

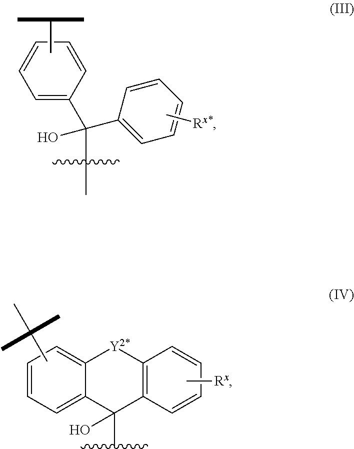

wherein, for each occurrence of the cross-linking moiety, the symbol [symbol] represents a point of attachment to L²* and the symbol [symbol] represents a point of attachment to a first repeat unit or a second repeat unit; and further wherein:

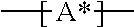

is a moiety represented by the following structural formula:

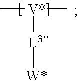

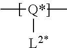

is a moiety represented by one of the following structural formulas:

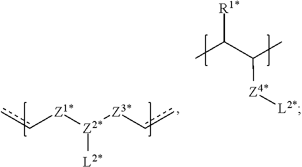

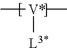

is a moiety represented by one of the following structural formulas:

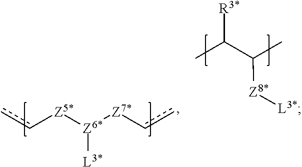

W is C₁₋₁₂ alkyl or a moiety represented by one of the structural formulas selected from:

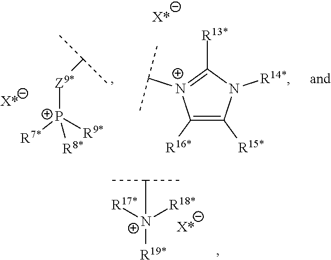

wherein:
   the symbol [symbol] represents a point of attachment to L³, and the symbol [symbol] represents a double bond or a single bond;
   Z¹*, Z³*, Z⁵*, and Z⁷* each independently is a C₁₋₃ alkylene or a bond;
      R¹* is selected from H, a C₁₋₁₂ alkyl, and C₆₋₁₂ aryl, and
      Z⁴* is a bond or a C₆₋₁₂ arylene, or
      Z⁴* is CH, and R¹* and Z⁴* together with the C₂ alkylene to which they are attached form a C₅₋₁₂ cycloalkyl or a 5 to 12-membered heterocyclyl; and
      Z⁶* is selected from —CHR⁶*—, a C₅₋₁₂ cycloalkylene, and a 5 to 16-membered heterocyclylene;
      R³* is selected from H, a C₁₋₁₂ alkyl, and C₆₋₁₂ aryl, and
      Z⁸* is a bond or a C₆₋₁₂ arylene, and CH, or
      Z⁸* is CH, and R³* and Z⁸* together with the C₂ alkylene to which they are attached form a C₅₋₁₂ cycloalkyl or a 5 to 12-membered heterocyclyl; and
      Z⁹* is NR¹⁰* or a bond;
      R⁵* and R⁶* each independently is H or a C₁₋₁₂ alkyl;
      R⁷*, R⁸*, and R⁹* each independently is selected from NR¹¹*R¹²*, a C₆₋₁₂ aryl, and 5 to 12-membered heterocyclyl;
      R¹⁰* is a C₁₋₁₂ alkyl;
      R¹¹* and R¹²* each independently is C₁₋₁₂ alkyl or a C₃₋₁₂ cycloalkyl, or R¹¹* and R¹²* together with the nitrogen atom to which they are attached form a 5 to 12-membered heterocyclyl;
      R¹³* is selected from a C₁₋₁₂ alkyl, C₆₋₁₂ aryl, and 5 to 12-membered heterocyclyl;
      R¹⁴* is a C₁₋₁₂ alkyl or a C₃₋₁₂ cycloalkyl;
      R¹⁵* and R¹⁶* each independently is selected from C₁₋₁₂ alkyl, C₆₋₁₂ aryl, and 5 to 12-membered heterocyclyl; or R¹⁵* and R¹⁶* together with the carbon atoms to which they are attached form a C₆₋₁₂ aryl or a 5 to 12-membered heterocyclyl; and
      R¹⁷*, R¹⁸*, and R¹⁹* each independently is a C₁₋₁₂ alkyl or a C₃₋₁₂ cycloalkyl; or
      R¹⁸* and R¹⁹* together with the nitrogen atom to which they are attached form a 5 to 12-membered heterocyclyl and (i) R¹⁷* is a C₁₋₁₂ alkyl or a C₃₋₁₂ cycloalkyl, or (ii) R¹⁷* and at least one atom of L³*, if present, together with the nitrogen atom to which L³* and R¹⁷* are attached form a 5- to 12-membered heterocyclyl; or
      R¹⁷*, R¹⁸*, and R¹⁹* together with the nitrogen atom to which they are attached form a bicyclic 5 to 12-membered heterocyclyl;
      R^{x}* is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl; and
      L²* is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ*, (C₁₋₁₂ alkylene-O)ₘ*, C(O)(O—C₁₋₁₂ alkylene)ₘ*, OC(O)(C₁₋₁₂ alkylene)ₘ*, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ*, (NH)C(O—C₁₋₁₂ alkylene)ₘ*, (NH—C₁₋₁₂ alkylene)ₘ*, and (C₁₋₁₂ alkylene-NH)ₘ*;
      L³* is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ*, (C₁₋₁₂ alkylene-O)ₙ*, C(O)(O—C₁₋₁₂ alkylene)ₙ*, OC(O)(C₁₋₁₂ alkylene)ₙ*, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ*, (NH)C(O—C₁₋₁₂ alkylene)ₙ*, (NH—C₁₋₁₂ alkylene)ₙ*, (C₁₋₁₂ alkylene-NH)ₙ*, and a bond;
      m* is an integer between 1 and 6;
      n* is an integer between 1 and 6;
      Y²* is selected from —C(═O)—, O, S, NH, N(C₁₋₁₂ alkyl), and a bond;
      X*⁻ is selected from F⁻, Cl⁻, Br⁻, OH⁻, NO⁻₂, CN⁻, HCO₃⁻, CO₃²⁻, PF₆⁻, BF₄⁻, a C₁₋₁₂ carboxylate and a C₁₋₁₂ alkoxide;
      provided that W* is C₁₋₁₂ alkyl only when V* is a cationic moiety, and wherein:
      each C₁₋₁₂ alkylene, C₆₋₁₂ arylene, C₅₋₁₂ cycloalkylene, 5 to 16-membered heterocyclylene, C₁₋₁₂ alkyl, C₃₋₁₂ cycloalkyl, C₅₋₁₂ cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

In a seventy-fifth aspect of the first embodiment,

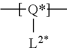

is a moiety represented by the following structural formula:

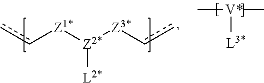

is a moiety represented by the following structural formula:

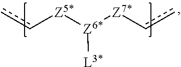

is a C₁₋₁₂ alkyl or a moiety represented the following structural formula:

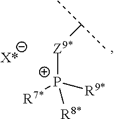

and each cross-linking moiety is represented by structural formula (III). The remainder of features and example features of the seventy-fifth aspect is as described above with respect to the first through seventy-fourth aspects of the first embodiment.

In a seventy-sixth aspect of the first embodiment,

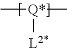

is a moiety represented by the following structural formula:

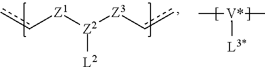

is a moiety represented by the following structural formula:

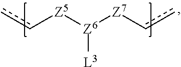

W* is a C₁₋₁₂ alkyl or a moiety represented the following structural formula:

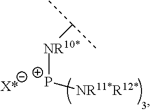

and each cross-linking moiety is represented by structural formula (III). The remainder of features and example features of the seventy-sixth aspect is as described above with respect to the first through seventy-fifth aspects of the first embodiment.

In a seventy-seventh aspect of the first embodiment,

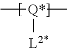

is moiety represented by the following structural formula:

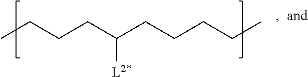

is a moiety represented by the following structural formula:

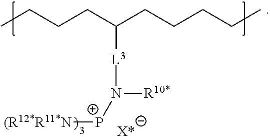

The remainder of features and example features of the seventy-seventh aspect is as described above with respect to the first through seventy-sixth aspects of the first embodiment.

In a seventy-eighth aspect of the first embodiment,

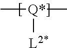

is a moiety represented by the following structural formula:

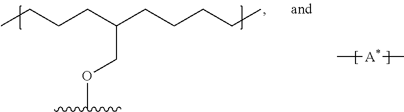

is a moiety represented by one of the following structural formulas:

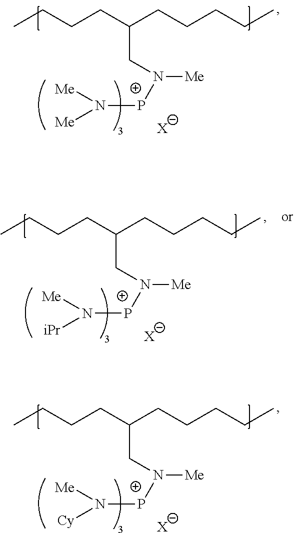

wherein Me is methyl, iPr is isopropyl, and Cy is cyclohexyl. The remainder of features and example features of the seventy-eighth aspect is as described above with respect to the first through seventy-seventh aspects of the first embodiment.

In a seventy-ninth aspect of the first embodiment, the second cross-linked ionomer further comprises a plurality of fourth repeat units represented by the following structural formula:

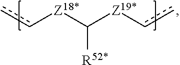

wherein:
Z¹⁸* and Z¹9* each independently is a C₁₋₃ alkylene or a bond;
R⁵²* is H, a C₁₋₁₂ alkyl, or a C₆₋₁₂ aryl.

In some instances, at least one fourth repeat unit is connected to a cross-linking moiety represented by structural formula (III) or (IV) through the point of attachment on the cross-linking moiety designated as [symbol] . The remainder of features and example features of the seventy-ninth aspect is as described above with respect to the first through seventy-eighth aspects of the first embodiment.

In an eightieth aspect of the first embodiment, the second cross-linked ionomer is represented by one of the following structural formulas:

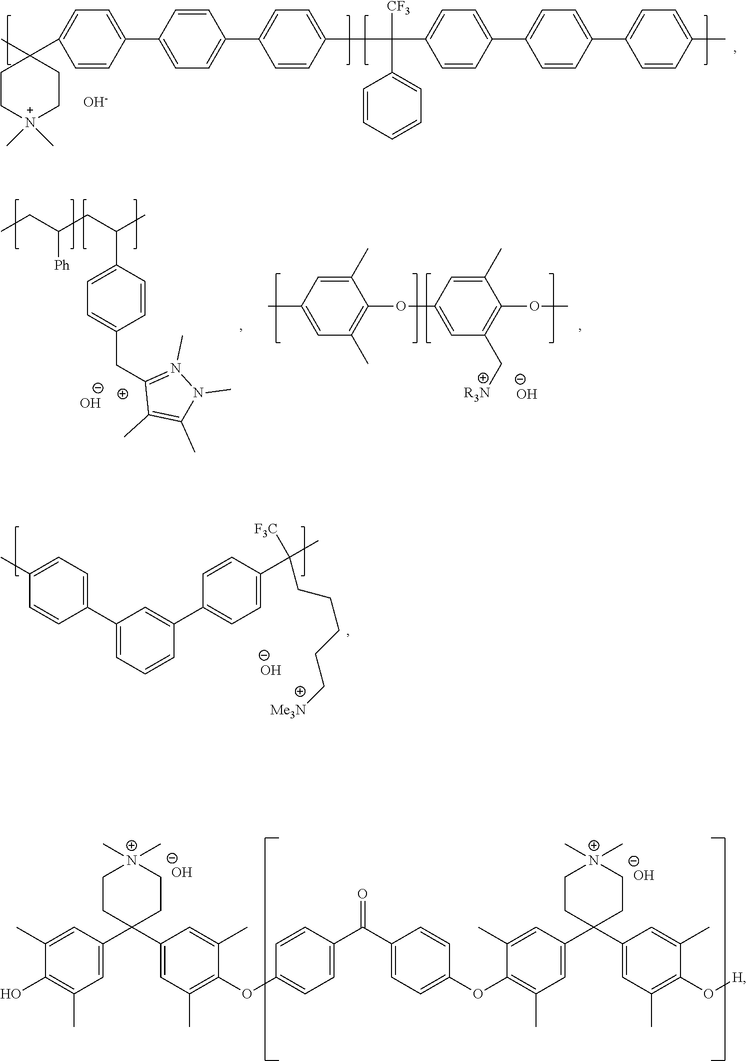

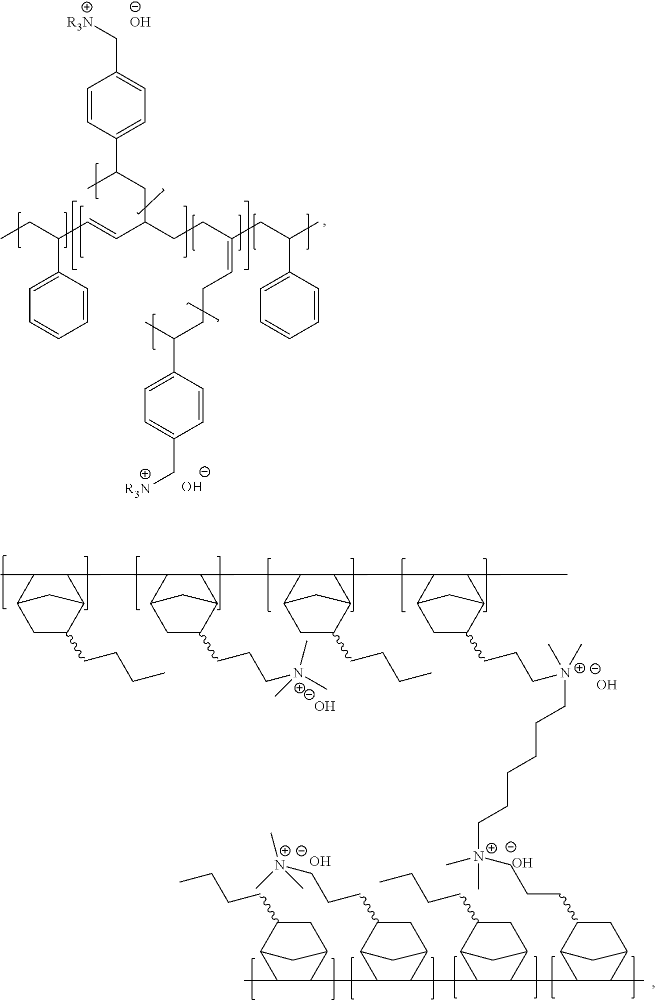

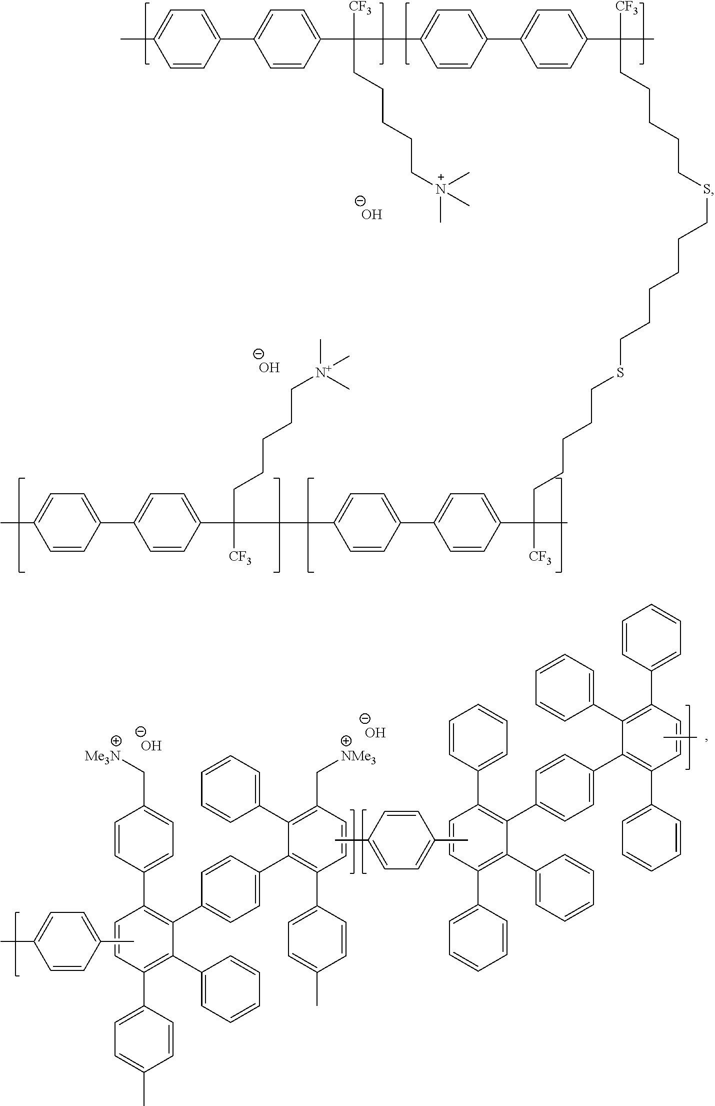

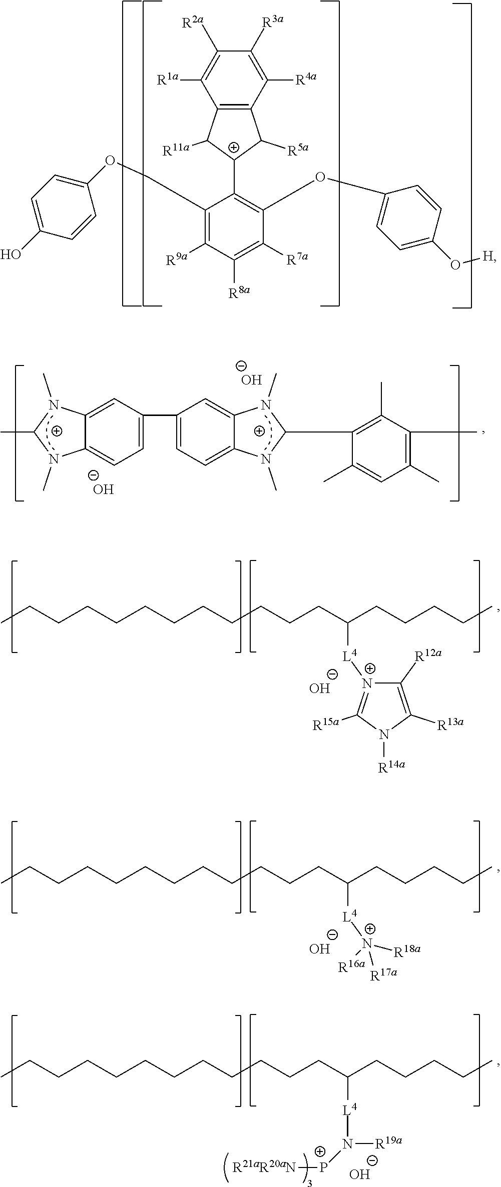

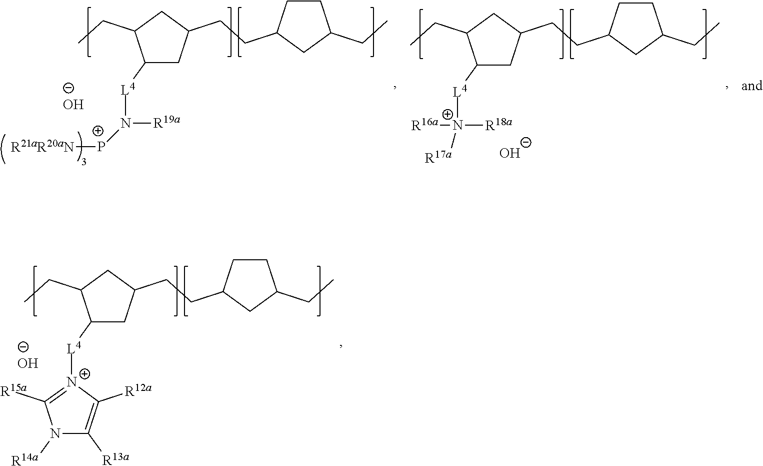

wherein:
R, R^{1a}, R^{2a}, R^{3a}, R^{4a}, R^{5a}, R^{7a}, R^{8a}, R^{9a}, R^{11a}, R^{12a}, R^{13a}, R^{14a}, R^{15a}, R^{16a}, R^{17a}, R^{18a}, R^{19a}, R^{20a}, and R^{21a} is each independently selected from H, a C₁₋₃ alkyl, C₆₋₁₂ aryl, and C₅₋₁₂ cycloalkyl,
L⁴ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₚ, (C₁₋₁₂ alkylene-O)ₚ, C(O)(O—C₁₋₁₂ alkylene)ₚ, OC(O)(C₁₋₁₂ alkylene)ₚ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₚ, (NH)C(O—C₁₋₁₂ alkylene)ₚ, (NH—C₁₋₁₂ alkylene)ₚ, (C₁₋₁₂ alkylene-NH)ₚ, and a bond;
p is an integer between 1 and 6; and
each moiety within square brackets represents a repeat unit of the second ionomer. The remainder of features and example features of the eightieth aspect is as described above with respect to the first through seventy-ninth aspects of the first embodiment.

In an eighty-first aspect of the first embodiment, the support is a porous transport layer (PTL). For example, the PTL comprises a metal foam, metal fiber, metal felt, metal sintered fiber felt, expanded metal, stainless steel, carbon paper, carbon fiber paper, woven carbon fiber cloth, and graphite felt. For example, the PTL comprises Ni or stainless steel. The remainder of features and example features of the eighty-first aspect is as described above with respect to the first through eightieth aspects of the first embodiment.

In an eighty-second aspect of the first embodiment, R^{x} is H. Alternatively, R^{x} is selected from F, Cl, Br, OH, NH₂, NO₂, CN, and C₁₋₁₂ alkyl. For example, R^{x} is selected from F, C₁, CN, and C₁₋₆ alkyl. For example, R^{x} is selected from F, C₁, and C₁₋₃ alkyl. The remainder of features and example features of the eighty-second aspect is as described above with respect to the first through eighty-first aspects of the first embodiment.

In a second example embodiment the i the present disclosure relates to a method of making an MEA as described herein with respect to the first embodiment and various aspects thereof, comprising:
a) providing a suspension comprising a solution of a cross-linkable ionomer and the catalyst in a solvent,
b) contacting the support with the suspension, thereby producing a coated support, and
c) exposing the coated support to ultraviolet radiation for a time sufficient to cross-link the cross-linkable ionomer, wherein
   the cross-linkable ionomer comprises:
      a plurality of first repeat units represented by structural formula (III):

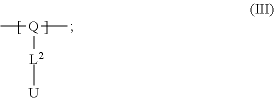

and
a plurality of second repeat units represented by structural formula (IV):

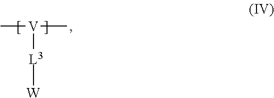

wherein:

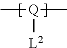

is a moiety represented by one of the following structural formulas:

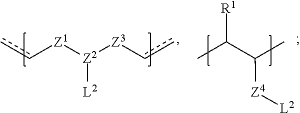

U is a moiety represented by one of the following structural formulas:

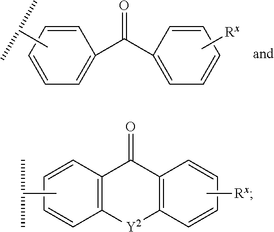

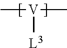

is a moiety represented by one of the following structural formulas:

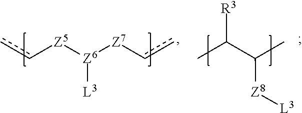

W is a C₁₋₁₂ alkyl or a moiety represented by one of the structural formulas selected from:

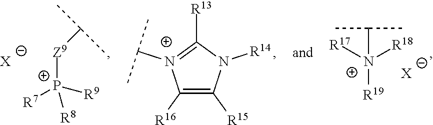

wherein:
   the symbol [symbol] represents a point of attachment to L², the symbol [symbol] represents a point of attachment to L³, and the symbol [symbol] represents a double bond or a single bond;
   Z¹, Z³, Z⁵, and Z⁷ each independently is a C₁₋₃ alkylene or a bond;
      R¹ is selected from H, a C₁₋₁₂ alkyl, and C₆₋₁₂ aryl, and
      Z⁴ is a bond or a C₆₋₁₂ arylene, or
      Z⁴ is CH, and R¹ and Z⁴ together with the C₂ alkylene to which they are attached form a C₅₋₁₂ cycloalkyl or a 5 to 12-membered heterocyclyl; and
      Z⁶ is selected from —CHR⁶—, a C₅₋₁₂ cycloalkylene, and a 5 to 16-membered heterocyclylene;
      R³ is selected from H, a C₁₋₁₂ alkyl, and C₆₋₁₂ aryl, and
      Z⁸ is a bond or a C₆₋₁₂ arylene, and CH, or
      Z⁸ is CH, and R³ and Z⁸ together with the C₂ alkylene to which they are attached form a C₅₋₁₂ cycloalkyl or a 5 to 12-membered heterocyclyl; and
      Z⁹ is NR¹⁰ or a bond;
      R⁵ and R⁶ each independently is H or a C₁₋₁₂ alkyl;
      R⁷, R⁸, and R⁹ each independently is selected from NR¹¹R¹², a C₆₋₁₂ aryl, and 5 to 12-membered heterocyclyl;
      R¹⁰ is a C₁₋₁₂ alkyl;
      R¹¹ and R¹² each independently is C₁₋₁₂ alkyl or a C₃₋₁₂ cycloalkyl, or R¹¹ and R¹² together with the nitrogen atom to which they are attached form a 5 to 12-membered heterocyclyl;
      R¹³ is selected from a C₁₋₁₂ alkyl, C₆₋₁₂ aryl, and 5 to 12-membered heterocyclyl;
      R¹⁴ is a C₁₋₁₂ alkyl or a C₃₋₁₂ cycloalkyl;
      R¹⁵ and R¹⁶ each independently is selected from C₁₋₁₂ alkyl, C₆₋₁₂ aryl, and 5 to 12-membered heterocyclyl; or R¹⁵ and R¹⁶ together with the carbon atoms to which they are attached form a C₆₋₁₂ aryl or a 5 to 12-membered heterocyclyl; and
      R¹⁷, R¹⁸, and R¹⁹ each independently is a C₁₋₁₂ alkyl or a C₃₋₁₂ cycloalkyl; or
      R¹⁸ and R¹⁹ together with the nitrogen atom to which they are attached form a 5 to 12-membered heterocyclyl and (i) R¹⁷ is a C₁₋₁₂ alkyl or a C₃₋₁₂ cycloalkyl, or (ii) R¹⁷ and at least one atom of L³ together with the nitrogen atom to which L³ and R¹⁷ are attached form a 5- to 12-membered heterocyclyl; or
R¹⁷, R¹⁸, and R¹⁹ together with the nitrogen atom to which they are attached form a bicyclic 5 to 12-membered heterocyclyl; and
R^{x} is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl;
L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ;
L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond;
m is an integer between 1 and 6;
n is an integer between 1 and 6;
Y² is selected from —C(O)—, —O—, —S—, —NH—, —N(C₁₋₁₂ alkyl)-, and a bond;
X⁻ is selected from F⁻, Cl⁻, Br⁻, OH⁻, NO⁻₂, CN⁻, HCO₃⁻, CO₃²⁻, PF₆⁻, BF₄⁻, and a C₁₋₁₂ carboxylate;
provided that W is C₁₋₁₂ alkyl only when V is a cationic moiety, and wherein:
each C₁₋₁₂ alkylene, C₆₋₁₂ arylene, C₅₋₁₂ cycloalkylene, 5 to 16-membered heterocyclylene, C₁₋₁₂ alkyl, C₃₋₁₂ cycloalkyl, C₅₋₁₂ cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

In a first aspect of the second embodiment, U is a moiety represented by the following structural formula:

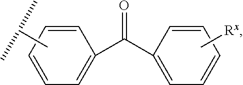

and W is a moiety represented by the following structural formula:

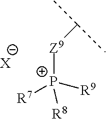

In a second aspect of the second embodiment, U is a moiety represented by the following structural formula:

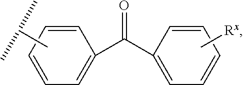

and W is a moiety represented by the following structural formula:

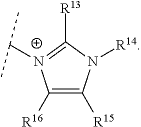

The remainder of features and example features of the second aspect is as described above with respect to the first aspect of the second embodiment.

In a third aspect of the second embodiment, U is a moiety represented by the following structural formula:

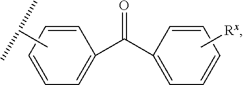

and W is a moiety represented by the following structural formula:

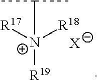

The remainder of features and example features of the third aspect is as described above with respect to the first through second aspects of the second embodiment.

In a fourth aspect of the second embodiment, U is a moiety represented by the following structural formula:

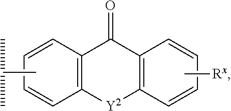

and W is a moiety represented by one of the following structural formulas:

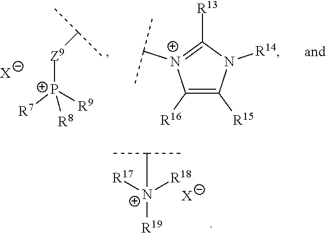

The remainder of features and example features of the fourth aspect is as described above with respect to the first through third aspects of the second embodiment.

In a fifth aspect of the second embodiment, Q, V, W, L², and L³ are as described in any of the twelfth through fifty-seventh aspects of the second embodiment. The remainder of features and example features of the fifth aspect is as described above with respect to the first through fourth aspects of the second embodiment.

In a sixth aspect of the second embodiment, the solvent is selected from water, 2-propanol, 1-propanol, ethanol, dipropylene glycol, N-methyl-2-pyrrolidone, and dimethylsulfoxide, or a combination thereof. For example, the solvent comprises water and 1-propanol. The remainder of features and example features of the sixth aspect is as described above with respect to the first through fifth aspects of the second embodiment.

In a seventh aspect of the second embodiment, the suspension comprises from about 0.1 wt. % to about 1 wt. % of the cross-linkable ionomer. For example, the suspension comprises from about 0.1 wt. % to about 1 wt. %, from about 0.1 wt. % to about 0.9 wt. %, from about 0.1 wt. % to about 0.8 wt. %, from about 0.1 wt. % to about 0.7 wt. %, from about 0.1 wt. % to about 0.6 wt. %, from about 0.1 wt. % to about 0.5 wt. %, from about 0.2 wt. % to about 1 wt. %, from about 0.2 wt. % to about 0.9 wt. %, from about 0.2 wt. % to about 0.8 wt. %, from about 0.2 wt. % to about 0.7 wt. %, from about 0.2 wt. % to about 0.6 wt. %, from about 0.2 wt. % to about 0.5 wt. %, from about 0.3 wt. % to about 0.9 wt. %, from about 0.3 wt. % to about 0.8 wt. %, from about 0.3 wt. % to about 0.7 wt. %, from about 0.3 wt. % to about 0.6 wt. % of the cross-linkable ionomer. For example, the suspension comprises about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1 wt. %, such as about 0.5 wt. % of the cross-linkable ionomer. The remainder of features and example features of the seventh aspect is as described above with respect to the first through sixth aspects of the second embodiment.

In an eighth aspect of the second embodiment, the ratio of the catalyst to the cross-linkable ionomer in the suspension is from about 1:1 to about 97:3 by weight. For example, the ratio of the catalyst to the ionomer in the suspension is from about 1:1 to about 95:5 by weight, from about 1:1 to about 9:1 by weight, from about 1:1 to about 8:1 by weight, from about 1:1 to about 7:1 by weight, from about 1:1 to about 6:1 by weight, from about 1:1 to about 5:1 by weight, from about 1:1 to about 4:1 by weight, from about 1:1 to about 3:1 by weight, from about 1:1 to about 2:1 by weight, from about 2:1 to about 9:1 by weight, from about 2:1 to about 8:1 by weight, from about 2:1 to about 9:1 by weight, from about 2:1 to about 8:1 by weight, from about 2:1 to about 7:1 by weight, from about 2:1 to about 6:1 by weight, from about 2:1 to about 5:1 by weight, from about 2:1 to about 4:1 by weight, from about 3:1 to about 9:1 by weight, from about 3:1 to about 8:1 by weight, from about 3:1 to about 7:1 by weight, from about 3:1 to about 6:1 by weight, from about 3:1 to about 5:1 by weight, from about 3:1 to about 4:1 by weight, from about 2:1 to about 3:1 by weight, from about 4:1 to about 9:1 by weight, from about 4:1 to about 8:1 by weight, from about 4:1 to about 7:1 by weight, from about 4:1 to about 6:1 by weight, from about 4:1 to about 5:1 by weight, from about 5:1 to about 9:1 by weight, from about 5:1 to about 8:1 by weight, from about 5:1 to about 7:1 by weight, from about 5:1 to about 6:1 by weight, from about 6:1 to about 9:1 by weight, from about 6:1 to about 8:1 by weight, from about 6:1 to about 7:1 by weight, from about 7:1 to about 9:1 by weight, from about 7:1 to about 8:1 by weight, or from about 8:1 to about 9:1 by weight. For example, the ratio of the catalyst to the cross-linkable ionomer in the suspension is about 1:1 by weight, about 2:1 by weight, about 3:1 by weight, about 4:1 by weight, about 5:1 by weight, about 6:1 by weight, about 7:1 by weight, about 8:1 by weight, or about 9:1 by weight. For example, the ratio of the catalyst to the ionomer in the suspension is about 9:1 by weight. The remainder of features and example features of the eighth aspect is as described above with respect to the first through seventh aspects of the second embodiment.

In a ninth aspect of the second embodiment, the contacting comprises spray coating. The remainder of features and example features of the ninth aspect is as described above with respect to the first through eighth aspects of the second embodiment.

In a tenth aspect of the second embodiment, the coated support does not comprise an external radical initiator. As used herein, the term “external radical initiator” refers to a radical initiator that is not covalently attached to the ionomer. The remainder of features and example features of the tenth aspect is as described above with respect to the first through ninth aspects of the second embodiment.

In a third example embodiment the present disclosure relates to a fuel cell comprising an MEA described herein with respect to the first embodiment and various aspects thereof, a source of fuel, and an oxidant.

In a first aspect of the third embodiment, the fuel is humidified.

In a second aspect of the third embodiment, the fuel is selected from hydrogen, methanol, ethanol, and ammonia. The remainder of features and example features of the second aspect is as described above with respect to the first aspect of the third embodiment.

In a third aspect of the third embodiment, the oxidant is oxygen. The remainder of features and example features of the third aspect is as described above with respect to the first and second aspects of the third embodiment.

In a fourth example embodiment the present disclosure relates to an electrolyzer comprising an MEA described herein with respect to the first embodiment and various aspects thereof and an electrolyte source.

In a first aspect of the fourth embodiment, the electrolyte source comprises water, a metal hydroxide, ethanol, methanol, ammonia, carbon dioxide, or a combination thereof.

### EXEMPLIFICATION

The examples below describe methods of synthesis of the ionomers and catalyst/ionomer layers of the present disclosure. The examples also provide methods of manufacturing and characterization of the MEAs of the disclosure.

### Abbreviations

COE cyclooctene
TEA triethylamine
THF tetrahydrofuran
ACN acetonitrile
Grubbs' Gen II catalyst (1,3-Bis(2,4,6-trimethylphenyl)-2-imidazolidinylidene)dichloro(phenylmethylene)(tricyclohexylphosphine)ruthenium
Crabtree's catalyst (1,5-Cyclooctadiene)(pyridine)(tricyclohexylphosphine)-Ir(I) PF₆

### Example 1. Synthesis of COE-Benzophenone Monomer

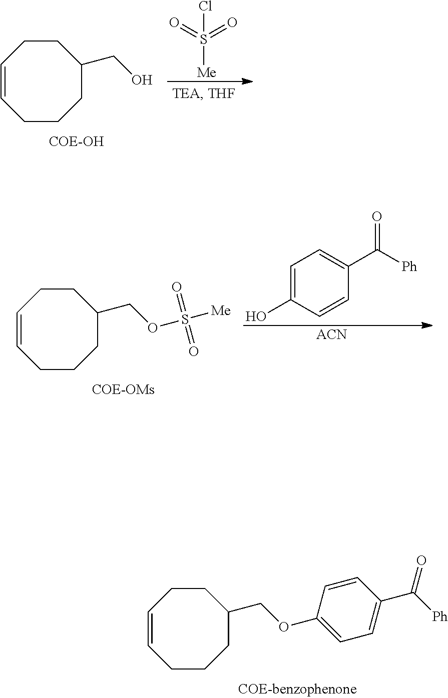

COE-OH (10 g, 71 mmol) was combined with triethylamine (8.1 g, 80 mmol) and tetrahydrofuran (anhydrous, 100 mL) in a 250 mL round bottom flask. The solution was cooled to 0° C. in an ice bath and methane sulfonyl chloride was added dropwise under the flow of nitrogen. The reaction was warmed to room temperature and allowed to stir for 24 h. The resulting heterogeneous mixture was filtered to remove solids and the organic layer was concentrated, in vacuo, to remove tetrahydrofuran. The crude oil was dissolved in diethyl ether and washed with KOH (1M), water, and brine. The organic layer was dried over magnesium sulfate and concentrated, in vacuo, to produce COE-OMs as a light yellow oil (13.3 g). COE-OMs (5 g, 23 mmol) was combined in a 250 mL round bottom flask with potassium carbonate (7 g, 50 mmol), acetonitrile (50 mL) and 4-hydroxybenzophenone (4.8 g, 24 mmol). The round bottom flask was fitted with a reflux condenser and the reaction was heated to reflux for 24 h. The reaction was cooled, filtered, and concentrated, in vacuo, to remove acetonitrile. The resulting crude oil was dissolved in ethyl acetate and washed with 1M KOH, water, and brine. The organic layer was dried over magnesium sulfate, filtered, and concentrated, in vacuo, to produce COE-Benzophenone as an off-white, waxy solid (4.1 g).

### Example 2. Synthesis of Cyclohexyl-Methyl Tetrakis® Monomer (3)

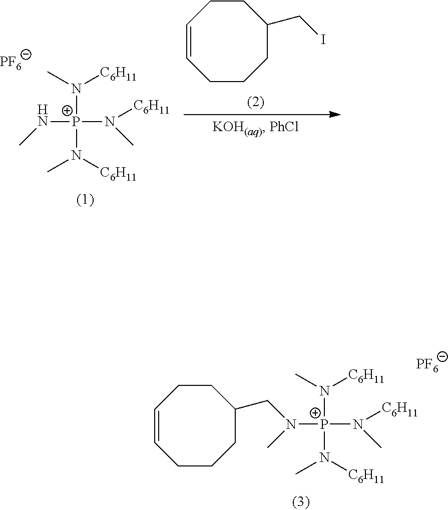

Tris(cyclohexyl(methyl)amino)(methylamino)phosphonium hexafluorophosphate (1) was synthesized as detailed in Treichel, M. et al. Macromolecules, 2020, 53, 8509.

Compound (1) (5.0 g, 9 mmol) was combined with chlorobenzene (16 mL) in a 250 mL round bottom flask. A potassium hydroxide solution (50 wt %, 10.0 g, 178 mmol) was charged followed by COE-iodide (2) (3.5 g, 14 mmol). The reaction was heated to 60° C. for 24 h. The reaction was cooled and layers separated. The aqueous layer was extracted with dichloromethane and all organic layers were washed with 1M HCl, saturated potassium hexafluorophosphate, and water. The organic layer was dried over magnesium chloride, concentrated, in vacuo, to produce a crude oil. The oil was dissolved in a minimal amount of dichloromethane and precipitated into diethyl ether to produce Tetrakis® monomer (3) as an off-white solid (3.5 g).

### Example 3. Synthesis of COE-Imidazolium Monomer (5)

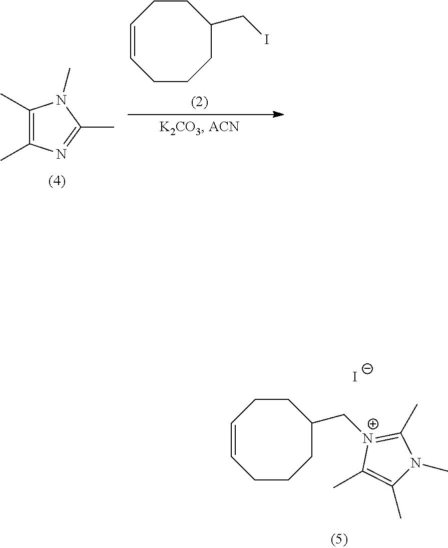

Tetramethyl imidazole (4) (3.0 g, 24 mmol) was combined with acetonitrile (16 mL) and potassium carbonate (3.3 g, 24 mmol) in a 50 mL round bottom flask. COE-iodide (2) (9 g, 36 mmol) was charged to the flask and the reaction was heated at 80° C. for 19 h. The reaction was cooled, filtered, and concentrated, in vacuo, to an oil. The collected oil was dissolved in dichloromethane, extracted with water, and dried over magnesium sulfate. The dichloromethane layer was filtered and precipitated into diethyl ether to produce COE-Imidazolium monomer (5) as a tan solid (5.7 g)

### Example 4. Synthesis of Tetrakis®-BXL Ionomer Containing Cross-Linkable Benzophenone

Tetrakis®-BXL ionomer refers to an ionomer comprising first repeat units containing benzophenone moieties, and second repeat units containing Tetrakis® cations. Tetrakis® Monomer (3) (0.63 g, 1.1 mmol), COE-Benzophenone (0.07 g, 0.20 mmol), and cyclooctene (0.30 g, 2.7 mmol) were dissolved in dichloromethane while under inert atmosphere. Grubbs' Gen II catalyst (7 mg, 0.01 mmol) was added to the solution and the reaction was stirred for 18 h. The resulting polymer was dissolved in a 2:1 (v:v) dichloromethane:methanol mixture and added to a pressure vessel. Crabtree's catalyst (10 mg, 0.01 mmol) was added, and the reaction was pressurized to 800 psi of hydrogen and heated to 55° C. for 17 h. The reaction was cooled to room temperature and the solvent removed to produce 0.96 g of a Tetrakis-BXL ionomer (28 mol % cationic units, 5 mol % cross-linkable units).

### Example 5. Synthesis of Imidazolium-BXL Ionomer Containing Cross-Linkable Benzophenone

Imidazolium-BXL ionomer refers to an ionomer comprising first repeat units containing benzophenone moieties, and second repeat units containing imidazolium cations. COE-Imidazolium Monomer (5) (0.86 g, 2.3 mmol), COE-Benzophenone (0.05 g, 0.16 mmol), and cyclooctene (0.09 g, 0.82 mmol) were dissolved in dichloromethane while under inert atmosphere. Grubbs' Gen II catalyst (4 mg, 0.005 mmol) was added to the solution and the reaction was stirred for 18 h. The resulting polymer was dissolved in a 2:1 (v:v) dichloromethane:methanol mixture and added to a pressure vessel. Crabtree's catalyst (5 mg, 0.007 mmol) was added, and the reaction was pressurized to 800 psi of hydrogen and heated to 55° C. for 17 h. The reaction was cooled to room temperature and the solvent removed to produce 0.82 g of Imidazolium-BXL ionomer (70 mol % cationic units, 5 mol % cross-linkable units).

### Example 6. Synthesis of Imidazolium Ionomer (No Cross-Linkable Repeat Units)

COE-Imidazolium Monomer (5) (0.89 g, 2.4 mmol) and cyclooctene (0.11 g, 1.0 mmol) were dissolved in dichloromethane while under inert atmosphere. Grubbs' Gen II catalyst (4 mg, 0.005 mmol) was added to the solution and the reaction was stirred for 18 h. The resulting polymer was dissolved in a 2:1 (v:v) dichloromethane:methanol mixture and added to a pressure vessel. Crabtree's catalyst (5 mg, 0.007 mmol) was added, and the reaction was pressurized to 800 psi of hydrogen and heated to 55° C. for 17 h. The reaction was cooled to room temperature and the solvent removed to produce 0.8 g of an Imidazolium ionomer (70 mol % cationic units, no cross-linkable repeat units).

### Example 7. Synthesis of a Cathode Gas Diffusion Electrode with 5 Mol % Cross-Linkable Units

Imidazolium-BXL ionomer (70 mol % cation and 5 mol % cross-linkable units) was combined with 1-propanol to form a 5 wt % solution. The mixture was heated to 60° C. and stirred for 1 h. The ionomer solution (1.2 g) was slowly added to a stirring mixture of ultrapure water (5.8 g 18 MΩ-cm), n-propanol (5.8 g), and Ni_{0.5}Fe_{0.5}Co₂O₄ catalyst (0.6 g). The ionomer/catalyst slurry was stirred at 60° C. for 10 min. The slurry was bath sonicated, at room temperature for 30 min, and probe sonicated for 1 h, in an ice bath. This produced a catalyst/ionomer slurry, in n-propanol/water, with a catalyst:ionomer composition ratio of 90:10 (w/w).

The 90:10 (w/w) catalyst:ionomer slurry was transferred to an air spray gun (iwata model HP-CS) and manually sprayed on a 25 cm² piece of nickel fiber gas diffusion layer (GDL). The GDL was heated to 65° C. and allowed to dry between coats. After a gravimetric determination of a 7.0 mg/cm² catalyst/ionomer loading (6.3 mg catalyst/cm²) the GDE was allowed to fully dry at 65° C. for at least 1 h.

### Example 8. Synthesis of an Anode GDE with 5 Mol % Cross-Linkable Units

The same procedure detailed in Example 7 was repeated using a NiFe₂O₄ catalyst and a stainless-steel fiber gas diffusion layer. This procedure was used to produce a GDE anode with 6.3 mg catalyst/cm² loading.

### Example 9. Cross-linking of a Benzophenone-Containing Gas Diffusion Electrodes

Anode and cathode electrodes containing cross-linkable benzophenone ionomers were placed under a UV lamp (365 nm wavelength, 100 W) and cross-linked between 4-24 h.

### Example 10. Synthesis of a Catalyst Coated Membrane Containing 5 Mol % Cross-Linkable Repeat Units

1. Ni_{0.5}Fe_{0.5}Co₂O₄ as Catalyst.

Imidazolium-BXL ionomer (70 mol % cation and 5 mol % cross-linkable units) was combined with n-propanol to form a 5 wt % solution. The mixture was heated to 60° C. and stirred for 1 h. The ionomer solution (1.2 g) was slowly added to a stirring mixture of ultrapure water (5.8 g, 18 MΩ-cm), n-propanol (5.8 g), and Ni_{0.5}Fe_{0.5}Co₂O₄ (0.6 g) to produce a slurry with a catalyst/ionomer ratio of 90:10 (w/w). The ionomer/catalyst slurry was stirred at 60° C. for 10 min. The slurry was bath sonicated, at room temperature for 30 min, and probe sonicated for 1 h, in an ice bath, to produce the cathode catalyst/ionomer slurry.

2. NiFe₂O₄ as Catalyst.

Imidazolium-BXL ionomer (70 mol % cation and 5 mol % cross-linkable units) is combined with n-propanol to form a 5 wt % solution. The mixture is heated to 60° C. and stirred for 1 h. The ionomer solution (1.2 g) is slowly added to a stirring mixture of ultrapure water (5.8 g, 18 MΩ-cm), n-propanol (5.8 g), and NiFe₂O₄ catalyst (to produce a slurry with a targeted catalyst/ionomer ratio of 90:10 (w/w). The ionomer/catalyst slurry is stirred at 60° C. for 10 min. The slurry is bath sonicated, at room temperature for 30 min, and probe sonicated for 1 h, in an ice bath to produce the anode catalyst/ionomer slurry.

A 50 cm² piece of Tetrakis® alkaline exchange membrane (AEM) is placed onto a heated vacuum table and masked with a piece of silicon rubber to reveal a 5 cm² coating area. The Tetrakis® AEM comprises a polymer of the following structure:

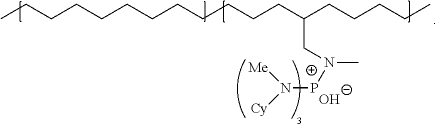

The table is heated to 80° C. and equilibrated for 30 min. The 90:10 (w/w) cathode catalyst/ionomer slurry was transferred to an air spray gun (Anest Iwata Spray Gun, model HP-CS) and manually sprayed onto the 5 cm² exposed area of the Tetrakis® AEM. The membrane is allowed to cool to room temperature and catalyst loading confirmed gravimetrically.

The coated membrane is flipped over to reveal the anode side and the previous coating process is repeated using the anode catalyst/ionomer slurry. After cooling to room temperature, each side of the catalyst coated membrane is treated with UV-light (365 nm) to cross-link.

### Example 11. Synthesis of Cathode Gas Diffusion Electrode without Cross-Linkable Units

Imidazolium ionomer (70 mol % cation repeat units and no cross-linkable units) was combined with n-propanol to form a 5 wt % solution. The mixture was heated to 60° C. and stirred for 1 h. The ionomer solution (1.2 g) was slowly added to a stirring mixture of ultrapure water (5.8 g 18 MΩ-cm), n-propanol (5.8 g), and Ni_{0.5}Fe_{0.5}Co₂O₄ catalyst (0.6 g). The ionomer/catalyst slurry was stirred at 60° C. for 10 min. The slurry was bath sonicated, at room temperature for 30 min, and probe sonicated for 1 h, in an ice bath. This produced a catalyst/ionomer slurry, in n-propanol/water, with a catalyst:ionomer composition ratio of 90:10 (w/w).

The 90:10 (w/w) catalyst:ionomer slurry in was transferred to an air spray gun (iwata model HP-CS) and manually sprayed on a 25 cm² piece of nickel fiber gas diffusion layer (GDL). The GDL was heated to 65° C. and allowed to dry between coats. After a gravimetric determination of a 7.0 mg/cm² catalyst/ionomer loading (6.3 mg catalyst/cm²) the GDE was allowed to fully dry at 65° C. for at least 1 h.

### Example 12. Synthesis of an Anode GDE without Cross-Linkable Units

The same procedure detailed in Example 11 was repeated using a NiFe₂O₄ catalyst and a stainless-steel fiber gas diffusion layer. This procedure was used to produce a GDE anode with 6.3 mg catalyst/cm² loading.

### Example 13. Electrolyzer Performance Testing

The anode and cathode GDEs were combined with a 50 μm thick film of a Tetrakis* membrane (composed of the ionomer prepared as described in Example 4, 50 μm thick film) and assembled in an electrolyzer device (5 cm², DM alkaline water electrolyzer cell). The electrolyzer was heated to 60° C., while flowing a supporting electrolyte (1M potassium hydroxide, 12 m/min), and equilibrated for 30 min. A polarization curve at 2.1V was obtained and the electrolyzer was heated to 80° C. After equilibrating at 80° C. for 30 min, another polarization measurement was taken. The polarizations curves at both 60° C. and 80° C. were standardized for the 5 cm² active area and plotted for analysis.

The performance testing above was performed with a set of cross-linked Imidazolium-BXL GDEs described in Examples 7, 8, 9. The same performance test was repeated using a set of non-crosslinked Imidazole GDEs described in Examples 11 and 12.

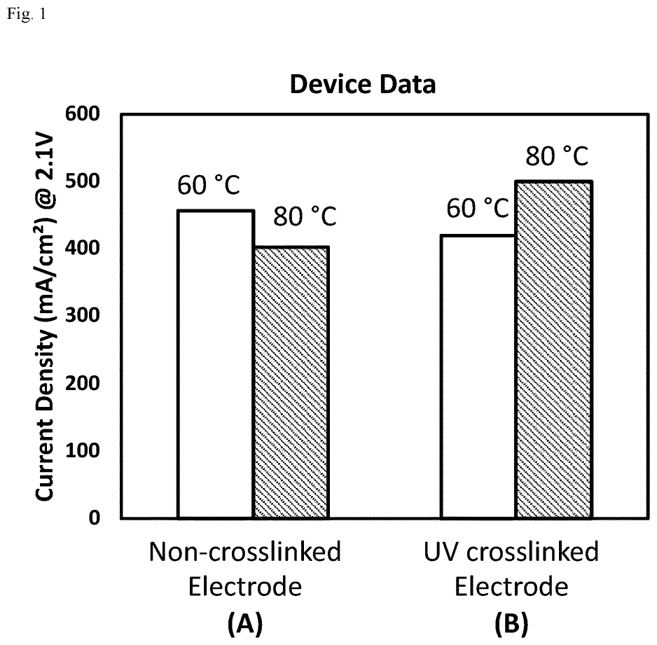

As shown in FIG. 1, the non-crosslinked electrode MEA showed modest performance at 60° C., but performance deteriorated at 80° C. In contrast, the performance of the cross-linked electrodes in the MEA of FIG. 1 improved dramatically in going from 60° C. to 80° C. While not being bound by theory, the results suggest that ionomer solubility at 80° C. and reduced physical contact of the catalyst and ionomer played a role in the reduced performance. These performance deficiencies were overcome with the UV cross-linkable electrode disclosed herein. When these UV crosslinkable ionomers are combined with electrode catalysts and built to form a MEA, the improved physical contact limits delamination of the catalyst layer, resulting in greater performance at elevated temperatures and voltages.

### Example 14. Electrode Adhesion Testing with Nickel/Imidazolium and Nickel/Imidazolium-BXL Ionomer Compositions

The electrode prepared in Example 7 and cross-linked with UV-light as in Example 9 was cut into a ca. 1×2 cm strip. This electrode was composed of a nickel fiber GDL coated with a 90:10 (w/w) mixture of Ni_{0.5}Fe_{0.5}Co₂O₄ catalyst and imidazolium-BXL ionomer (70 mol % cationic repeat units, 5 mol % cross-linkable units). The electrode strip was carefully attached to a ¼″ stainless steel sheet using double-stick foam tape.

An electrode composed of a nickel fiber GDL coated with a 90:10 (w/w) mixture of Ni_{0.5}Fe_{0.5}Co₂O₄ catalyst and imidazolium ionomer (70 mol % cationic repeat units, no cross-linkable units) was prepared as in Example 7. The prepared electrode was cut into ca. 1×2 cm strip and carefully attached to a ¼″ stainless steel sheet using double-stick foam tape.

A strip of Scotch tape (#2060, rough surface extra strength painter's tape) was placed over the GDE surface containing the catalyst/ionomer layer. The sample was covered with a ⅛″ acrylic sheet and a cylindrical weight (2.6 Kg) was rolled over the surface a total of five times. The Scotch tape was removed from the surface of the electrode in a slow gradual motion. This test was repeated a total of six times per electrode and the tape surface and electrode surface was visually evaluated after each test. Poor adhesion of the catalyst/ionomer layer to the gas diffusion layer (GDL) was observed in the non-crosslinked formulation. The cross-linked electrode shows a dramatic reduction in the amount of catalyst/ionomer layers that adhered to the adhesive tape, indicating greater binding of the catalyst/ionomer layer to the GDL.

While this invention has been particularly shown and described with references to example embodiments thereof, it will be understood by those skilled in the art that various changes in form and details may be made therein without departing from the scope of the invention encompassed by the appended claims.

The teachings of all patents, published applications and references cited herein are incorporated by reference in their entirety.

What is claimed is:

1. A membrane electrode assembly (MEA), comprising:
a support, and
a catalyst/ionomer layer, said catalyst/ionomer layer comprising a first cross-linked ionomer and a catalyst, wherein the first cross-linked ionomer comprises:
a plurality of first repeat units, wherein each first repeat unit is a moiety represented by a structural formula 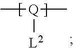
a plurality of second repeat units, wherein each second repeat unit is a moiety represented by a structural formula 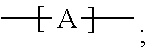
and a plurality of cross-linking moieties, wherein each cross-linking moiety is represented by structural formula (I) or (II): 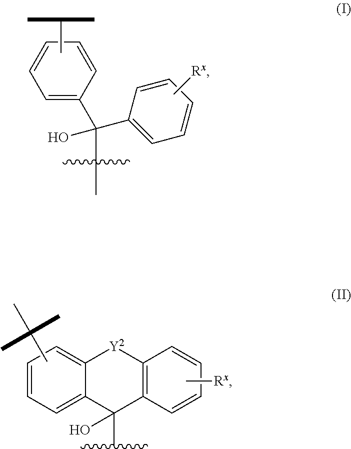
wherein, for each occurrence of the cross-linking moiety, the symbol [symbol] represents a point of attachment to L² and the symbol [symbol] represents a point of attachment to a first repeat unit or a second repeat unit;
and further wherein: 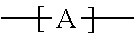
is a moiety represented by the following structural formula: 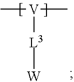 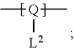
is a moiety represented by one of the following structural formulas: 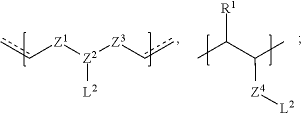 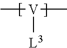
is a moiety represented by one of the following structural formulas: 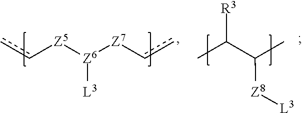
W is C₁₋₁₂ alkyl or a moiety represented by one of the structural formulas selected from: 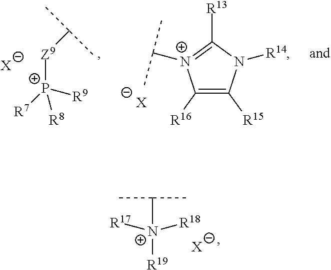
wherein:
the symbol [symbol] represents a point of attachment to L³, and the symbol [symbol] represents a double bond or a single bond;
Z¹, Z³, Z⁵, and Z⁷ each independently is a C₁₋₃ alkylene or a bond;
R¹ is selected from H, a C₁₋₁₂ alkyl, and C₆₋₁₂ aryl, and
Z⁴ is a bond or a C₆₋₁₂ arylene, or
Z⁴ is CH, and R¹ and Z⁴ together with the C₂ alkylene to which they are attached form a C₅₋₁₂ cycloalkyl or a 5 to 12-membered heterocyclyl; and
Z⁶ is selected from —CHR⁶—, a C₅₋₁₂ cycloalkylene, and a 5 to 16-membered heterocyclylene;
R³ is selected from H, a C₁₋₁₂ alkyl, and C₆₋₁₂ aryl, and
Z⁸ is a bond or a C₆₋₁₂ arylene, and CH, or
Z⁸ is CH, and R³ and Z⁸ together with the C₂ alkylene to which they are attached form a C₅₋₁₂ cycloalkyl or a 5 to 12-membered heterocyclyl; and
Z⁹ is NR¹⁰ or a bond;
R⁵ and R⁶ each independently is H or a C₁₋₁₂ alkyl;
R⁷, R⁸, and R⁹ each independently is selected from NR¹¹R¹², a C₆₋₁₂ aryl, and 5 to 12-membered heterocyclyl;
R¹⁰ is a C₁₋₁₂ alkyl;
R¹¹ and R¹² each independently is C₁₋₁₂ alkyl or a C₃₋₁₂ cycloalkyl, or R¹¹ and R¹² together with the nitrogen atom to which they are attached form a 5 to 12-membered heterocyclyl;
R¹³ is selected from a C₁₋₁₂ alkyl, C₆₋₁₂ aryl, and 5 to 12-membered heterocyclyl;
R¹⁴ is a C₁₋₁₂ alkyl or a C₃₋₁₂ cycloalkyl;
R¹⁵ and R¹⁶ each independently is selected from C₁₋₁₂ alkyl, C₆₋₁₂ aryl, and 5 to 12-membered heterocyclyl; or R¹⁵ and R¹⁶ together with the carbon atoms to which they are attached form a C₆₋₁₂ aryl or a 5 to 12-membered heterocyclyl; and
R¹⁷, R¹⁸, and R¹⁹ each independently is a C₁₋₁₂ alkyl or a C₃₋₁₂ cycloalkyl; or
R¹⁸ and R¹⁹ together with the nitrogen atom to which they are attached form a 5 to 12-membered heterocyclyl and (i) R¹⁷ is a C₁₋₁₂ alkyl or a C₃₋₁₂ cycloalkyl, or (ii) R¹⁷ and at least one atom of L³ together with the nitrogen atom to which L³ and R¹⁷ are attached form a 5- to 12-membered heterocyclyl; or
R¹⁷, R¹⁸, and R¹⁹ together with the nitrogen atom to which they are attached form a bicyclic 5 to 12-membered heterocyclyl; and
R^{x} is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl;
L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ;
L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond;
m is an integer between 1 and 6;
n is an integer between 1 and 6;
Y² is selected from —C(O)—, —O—, —S—, —NH—, —N(C₁₋₁₂ alkyl)-, and a bond;
X⁻ is selected from F⁻, Cl⁻, Br⁻, OH⁻, NO⁻₂, CN⁻, HCO₃⁻, CO₃²⁻, PF₆⁻, BF₄⁻, and a C₁₋₁₂ carboxylate;
provided that W is C₁₋₁₂ alkyl only when V is a cationic moiety,
and wherein:
each C₁₋₁₂ alkylene, C₆₋₁₂ arylene, C₅₋₁₂ cycloalkylene, 5 to 16-membered heterocyclylene, C₁₋₁₂alkyl, C₃₋₁₂cycloalkyl, C₅₋₁₂cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

2. The MEA of claim 1, wherein the first cross-linked ionomer further comprises a plurality of third repeat units, wherein each third repeat unit is a moiety represented by the following structural formula: 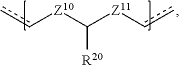
wherein
Z¹⁰ and Z¹¹ each independently is a C₁₋₃ alkylene or a bond;
R²⁰ is H, a C₁₋₁₂ alkyl, or a C₆₋₁₂ aryl.

3. The MEA of claim 1 or 2, wherein: 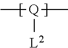
is a moiety represented by the following structural formula: 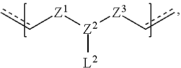 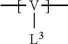
is a moiety represented by the following structural formula: 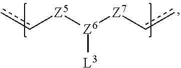
W is a C₁₋₁₂ alkyl or a moiety represented by the following structural formula: 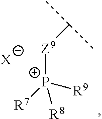
and
each cross-linking moiety is represented by structural formula (I).

4. The MEA of claim 1 or 2, wherein 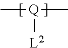
is a moiety represented by the following structural formula: 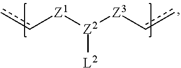 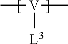
is a moiety represented by the following structural formula: 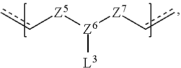
W is a C₁₋₁₂ alkyl or a moiety represented by the following structural formula: 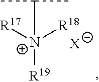
and
each cross-linking moiety is represented by structural formula (I).

5. The MEA of claim 1 or 2, wherein 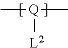
is a moiety represented by the following structural formula: 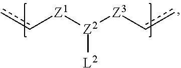 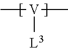
is a moiety represented by the following structural formula: 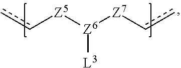
W is a C₁₋₁₂ alkyl or a moiety represented by the following structural formula: 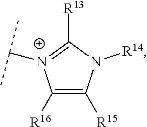
and
each cross-linking moiety is represented by structural formula (I).

6. The MEA of claim 2, wherein: 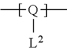
is a moiety represented by the following structural formula: 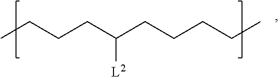 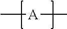
is a moiety represented by the following structural formula: 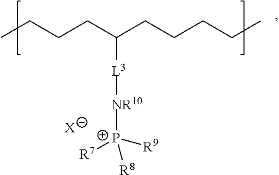
each third repeat unit is a C₈ alkylene, and
each cross-linking moiety is represented by structural formula (I).

7. The MEA of claim 2, wherein: 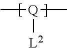
is a moiety represented by the following structural formula: 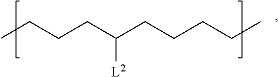 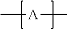
is a moiety represented by the following structural formula: 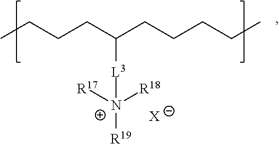
each third repeat unit is a C₈ alkylene, and
each cross-linking moiety is represented by structural formula (I).

8. The MEA of claim 2, wherein: 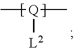
is a moiety represented by the following structural formula: 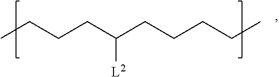 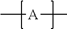
is a moiety represented by the following structural formula: 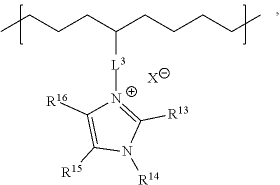
each third repeat unit is a C₈ alkylene, and
each cross-linking moiety is represented by structural formula (I).

9. The MEA of claim 8, wherein R¹³, R¹⁴, R¹⁵, and R¹⁶ are methyl, and wherein the molar ratio of the first repeat units, second repeat units, and third repeat units is 1:14:5.

10. The MEA of any one of claims 1-9, wherein the first cross-linked ionomer comprises from about 0.5 mol-% to about 15 mol-% of the first repeat units.

11. The MEA of claim 10, wherein the first cross-linked ionomer comprises about 5 mol-% of the first repeat units.

12. The MEA of any one of claims 1-11, wherein the first cross-linked ionomer comprises from about 20 mol-% to about 98 mol-% of the second repeat units.

13. The MEA of any one of claims 1-12, wherein the first cross-linked ionomer comprises from about 20 mol-% to about 50 mol-% or from about 50 mol-% to about 90 mol-% of the second repeat units.

14. The MEA of claim 13, wherein the first cross-linked ionomer comprises about 70 mol-% of the second repeat units.

15. The MEA of any one of claims 1-14, wherein the first cross-linked ionomer comprises from about 0 mol-% to about 70 mol-% of the third repeat units.

16. The MEA of claim 15, wherein the first cross-linked ionomer comprises about 25 mol-% of the third repeat units.

17. The MEA of any one of claims 1-16, wherein the number average molecular weight of the first cross-linked ionomer is from about 30,000 g/mol to about 500,000 g/mol.

18. The MEA of claim 17, wherein the number average molecular weight of the first cross-linked ionomer is from about 50,000 g/mol to about 360,000 g/mol.

19. The MEA of any one of claims 1-18, wherein the catalyst is dispersed within the catalyst/ionomer layer.

20. The MEA of any one of claims 1-19, wherein the catalyst comprises:
i) a metal selected from Ni, Fe, Ru, Ir, Co, Mn, Pt, Pd, Mo, and, La, or a combination thereof; and/or
(ii) an oxide of a metal selected from Ni, Fe, Ru, Ir, Co, Mn, Pt, Pd, Mo, and La, or a combination thereof.

21. The MEA of any one of claims 1-20, wherein the catalyst is supported on carbon.

22. The MEA of any one of claims 1-19, wherein the catalyst is selected from Pt, Pt supported on carbon (Pt/C), Pt and Ru supported on carbon (PtRu/C), Pd, Pd supported on carbon (Pd/C), Ir, IrO₂, IrRuO, RuO₂, Raney nickel (Al/Ni), Ni_{0.5}Co_{0.5}Fe₂O₄, NiCoO₂, NiFe, NiFe₂O₄, NiO, NiMo, Ni and Mo supported on carbon (NiMo/C), FeCoNi, Fe₂O₃, LaCoO₃, LiNiO₂, LiCoO₂, Co₃O₄, CoFe₂O₄, CoO, MnO, Mn₂O₃, MnO₂, and Mn₃O₄, or a combination thereof.

23. The MEA of claim 22, wherein the catalyst is selected from Pt, Pt/C, Ir, IrO₂, IrRuO, RuO₂, Ni_{0.5}Co_{0.5}Fe₂O₄, and NiCoO₂, or a combination thereof.

24. The MEA of claim 22, wherein the catalyst is selected from Raney nickel (Al/Ni), Ni_{0.5}Co_{0.5}Fe₂O₄, NiCoO₂, NiFe, NiFe₂O₄, NiO, NiMo, Ni and Mo supported on carbon (NiMo/C), FeCoNi, Fe₂O₃, LaCoO₃, LiNiO₂, LiCoO₂, Co₃O₄, CoFe₂O₄, CoO, MnO, Mn₂O₃, MnO₂, and Mn₃O₄, or a combination thereof.

25. The MEA of claim 22, wherein the catalyst is Ni_{0.5}Co_{0.5}Fe₂O₄ or NiFe₂O₄.

26. The MEA of any one of claims 1-25, wherein the catalyst/ionomer layer comprises about 50-97 wt. % catalyst and about 3-50 wt. % ionomer.

27. The MEA of claim 26, wherein the catalyst/ionomer layer comprises about 80-90 wt. % catalyst and about 10-20 wt. % ionomer.

28. The MEA of any one of claims 1-27, wherein the catalyst/ionomer layer is disposed on the support.

29. The MEA of any one of claims 1-28, wherein the support is an alkaline exchange membrane (AEM), said AEM comprising a second ionomer.

30. The MEA of claim 29, wherein the second ionomer is a second cross-linked ionomer comprising:
a plurality of first repeat units, wherein each first repeat unit is a moiety represented by structural formula 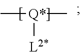
a plurality of second repeat units, wherein each second repeat unit is a moiety represented by structural formula 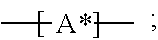
and a plurality of cross-linking moieties, wherein each crosslinking moiety is represented by structural formula (III) or (IV): 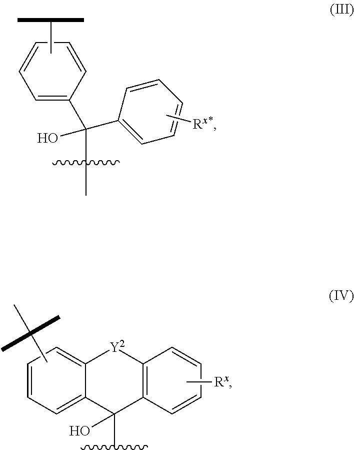
wherein, for each occurrence of the cross-linking moiety, the symbol [symbol] represents a point of attachment to L²* and the symbol [symbol] represents a point of attachment to a first repeat unit or a second repeat unit;
and further wherein: 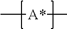
is a moiety represented by the following structural formula: 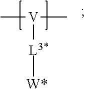 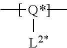
is a moiety represented by one of the following structural formulas: 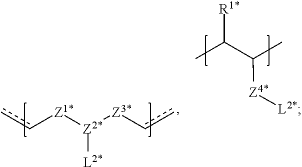 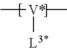
is a moiety represented by one of the following structural formulas: 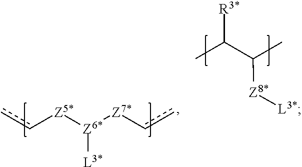
W is C₁₋₁₂ alkyl or a moiety represented by one of the structural formulas selected from: 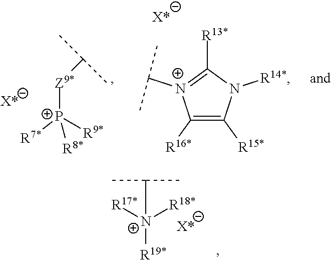
wherein:
the symbol [symbol] represents a point of attachment to L³, and the symbol [symbol] represents a double bond or a single bond;
Z¹*, Z³*, Z⁵*, and Z⁷* each independently is a C₁₋₃ alkylene or a bond;
R¹* is selected from H, a C₁₋₁₂ alkyl, and C₆₋₁₂ aryl, and
Z⁴* is a bond or a C₆₋₁₂ arylene, or
Z⁴* is CH, and R¹* and Z⁴* together with the C₂ alkylene to which they are attached form a C₅₋₁₂ cycloalkyl or a 5 to 12-membered heterocyclyl; and
Z⁶* is selected from —CHR⁶*—, a C₅₋₁₂ cycloalkylene, and a 5 to 16-membered heterocyclylene;
R³* is selected from H, a C₁₋₁₂ alkyl, and C₆₋₁₂ aryl, and
Z⁸* is a bond or a C₆₋₁₂ arylene, and CH, or
Z⁸* is CH, and R³* and Z⁸* together with the C₂ alkylene to which they are attached form a C₅₋₁₂ cycloalkyl or a 5 to 12-membered heterocyclyl; and
Z⁹* is NR¹⁰* or a bond;
R⁵* and R⁶* each independently is H or a C₁₋₁₂ alkyl;
R⁷*, R⁸*, and R⁹* each independently is selected from NR¹¹*R¹²*, a C₆₋₁₂ aryl, and 5 to 12-membered heterocyclyl;
R¹⁰* is a C₁₋₁₂ alkyl;
R¹¹* and R¹²* each independently is C₁₋₁₂ alkyl or a C₃₋₁₂ cycloalkyl, or R¹¹* and R¹²* together with the nitrogen atom to which they are attached form a 5 to 12-membered heterocyclyl;
R¹³* is selected from a C₁₋₁₂ alkyl, C₆₋₁₂ aryl, and 5 to 12-membered heterocyclyl;
R¹⁴* is a C₁₋₁₂ alkyl or a C₃₋₁₂ cycloalkyl;
R¹⁵* and R¹⁶* each independently is selected from C₁₋₁₂ alkyl, C₆₋₁₂ aryl, and 5 to 12-membered heterocyclyl; or R¹⁵* and R¹⁶* together with the carbon atoms to which they are attached form a C₆₋₁₂ aryl or a 5 to 12-membered heterocyclyl; and
R¹⁷*, R¹⁸*, and R¹⁹* each independently is a C₁₋₁₂ alkyl or a C₃₋₁₂ cycloalkyl; or
R¹⁸* and R¹⁹* together with the nitrogen atom to which they are attached form a 5 to 12-membered heterocyclyl and (i) R¹⁷* is a C₁₋₁₂ alkyl or a C₃₋₁₂ cycloalkyl, or (ii) R¹⁷* and at least one atom of L³*, if present, together with the nitrogen atom to which L³* and R¹⁷* are attached form a 5- to 12-membered heterocyclyl; or
R¹⁷*, R¹⁸*, and R¹⁹* together with the nitrogen atom to which they are attached form a bicyclic 5 to 12-membered heterocyclyl;
R^{x}* is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl; and
L²* is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ*, (C₁₋₁₂ alkylene-O)ₘ*, C(O)(O—C₁₋₁₂ alkylene)ₘ*, OC(O)(C₁₋₁₂ alkylene)ₘ*, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ*, (NH)C(O—C₁₋₁₂ alkylene)ₘ*, (NH—C₁₋₁₂ alkylene)ₘ*, and (C₁₋₁₂ alkylene-NH)ₘ*;
L³* is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ*, (C₁₋₁₂ alkylene-O)ₙ*, C(O)(O—C₁₋₁₂ alkylene)ₙ*, OC(O)(C₁₋₁₂ alkylene)ₙ*, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₙ*, (NH)C(O—C₁₋₁₂ alkylene)ₙ*, (NH—C₁₋₁₂ alkylene)ₙ*, (C₁₋₁₂ alkylene-NH)ₙ*, and a bond;
m* is an integer between 1 and 6;
n* is an integer between 1 and 6;
Y²* is selected from —C(═O)—, O, S, NH, N(C₁₋₁₂ alkyl), and a bond;
X*⁻ is selected from F⁻, Cl⁻, Br⁻, OH⁻, NO⁻₂, CN⁻, HCO₃⁻, CO₃²⁻, PF₆⁻, BF₄⁻, a C₁₋₁₂ carboxylate and a C₁₋₁₂ alkoxide;
provided that W* is C₁₋₁₂ alkyl only when V* is a cationic moiety, and wherein:
each C₁₋₁₂ alkylene, C₆₋₁₂ arylene, C₅₋₁₂ cycloalkylene, 5 to 16-membered heterocyclylene, C₁₋₁₂ alkyl, C₃₋₁₂ cycloalkyl, C₅₋₁₂ cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

31. The MEA of claim 29, wherein the second ionomer is represented by one of the following structural formulas: 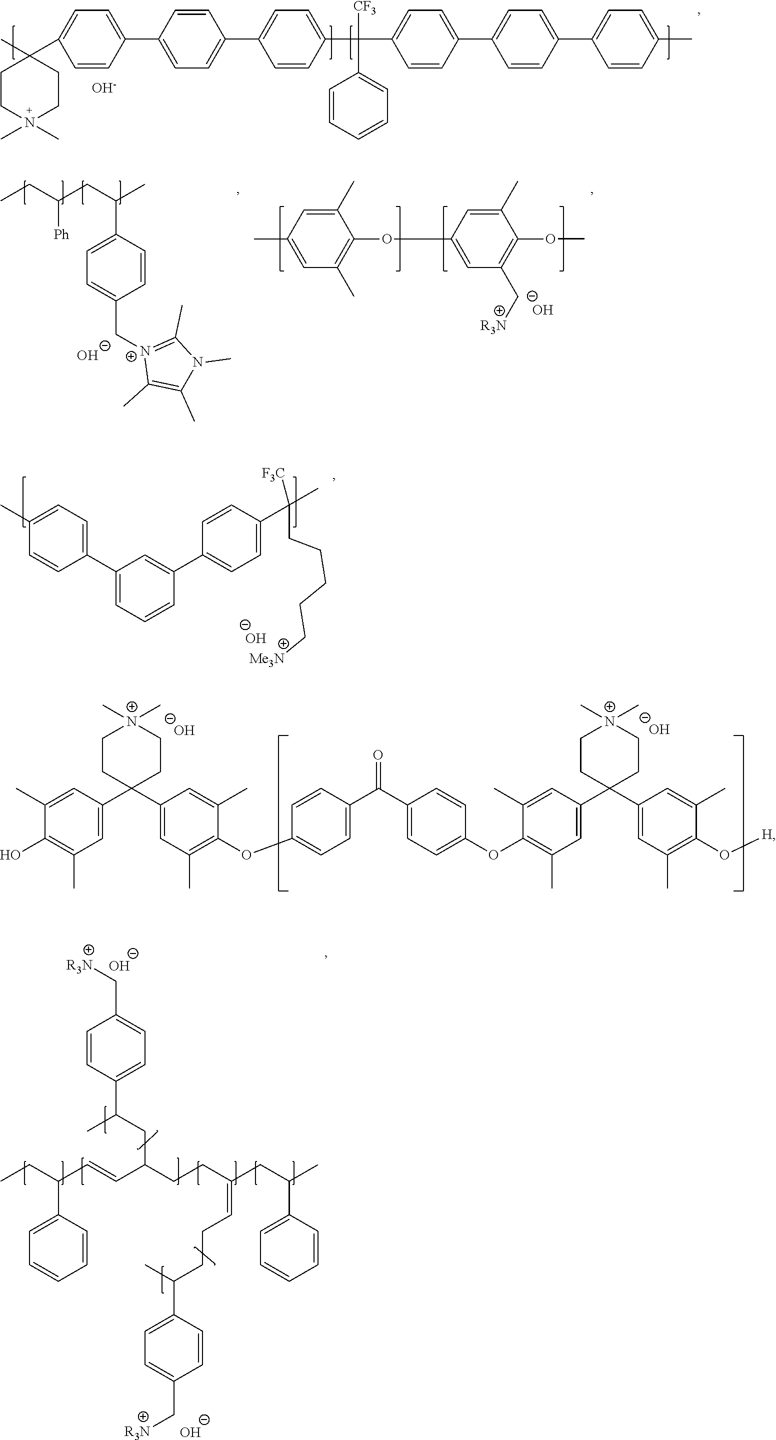 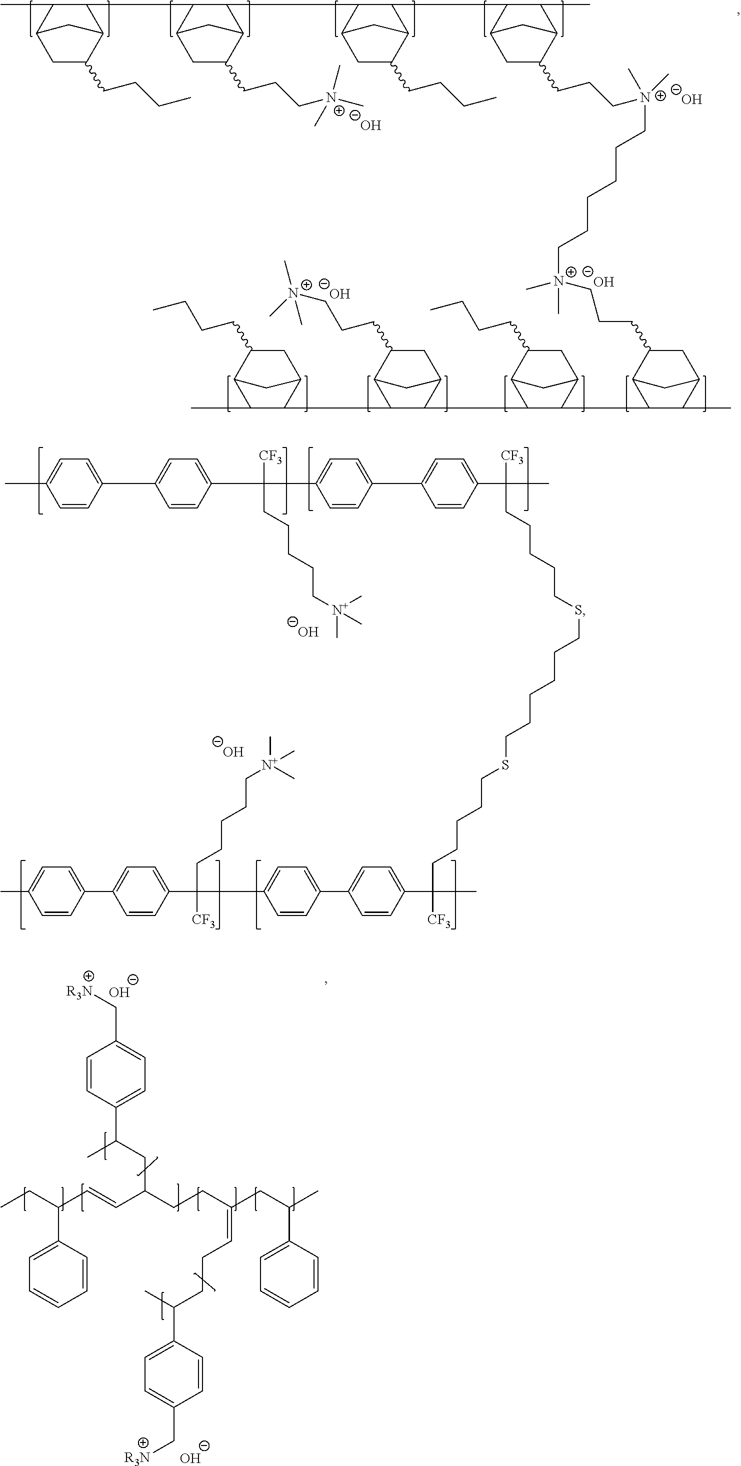 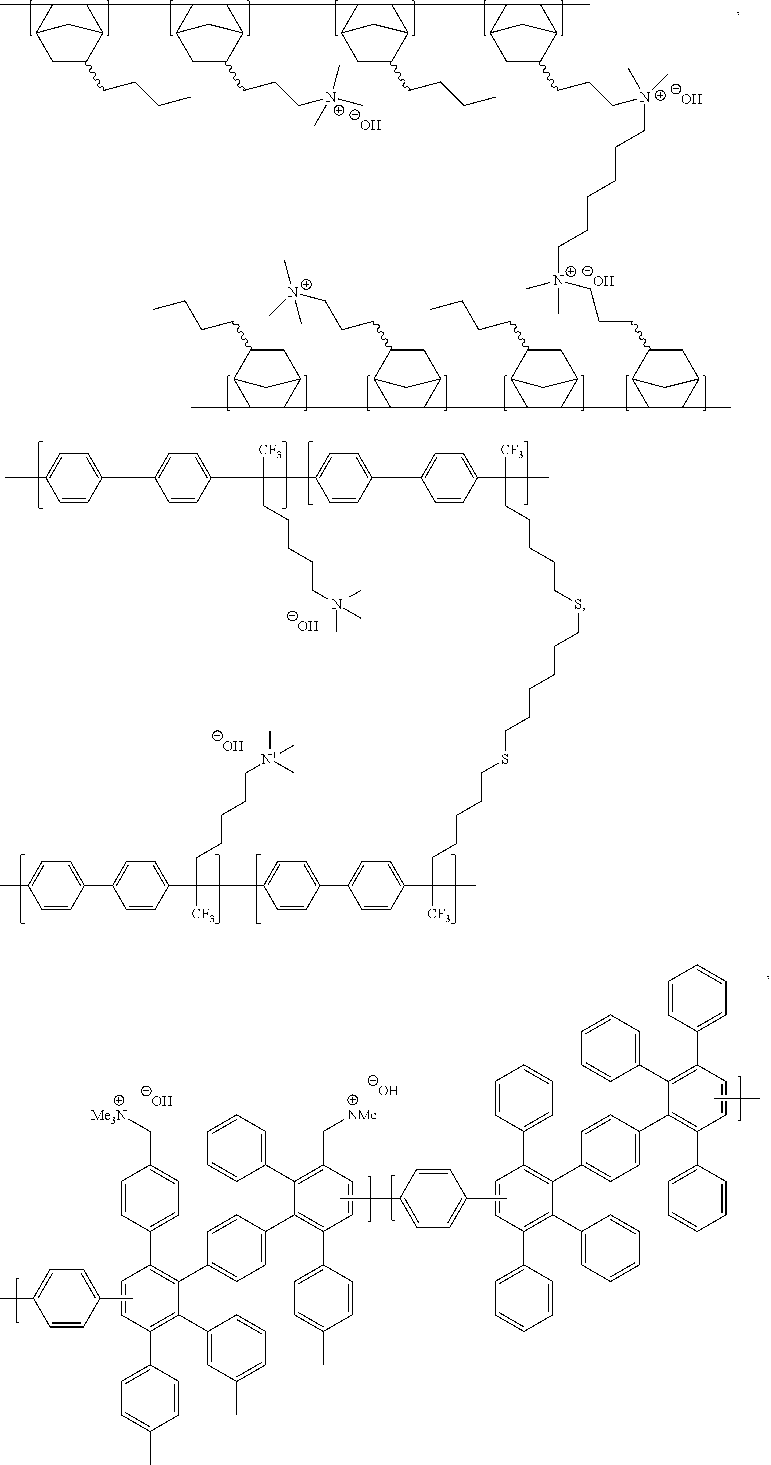 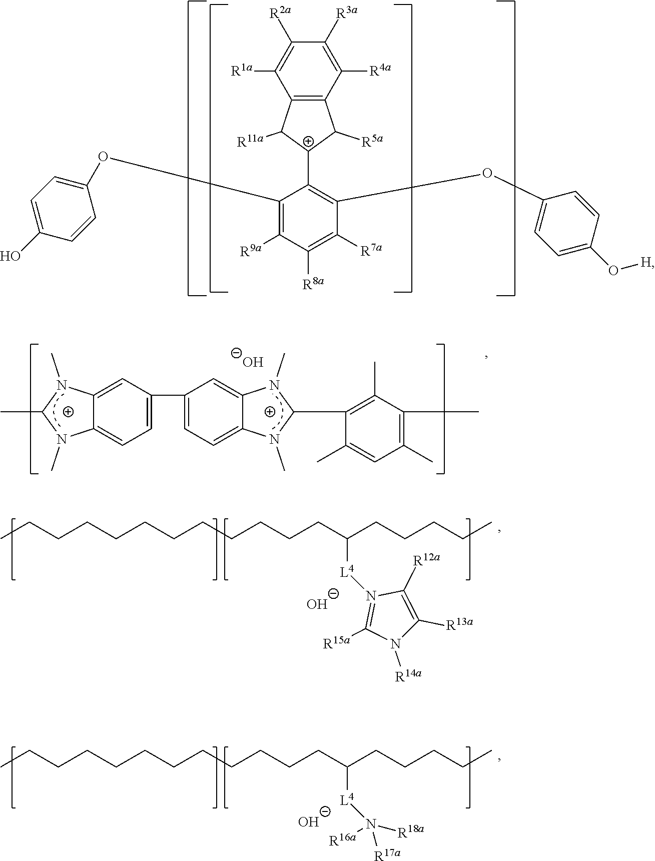 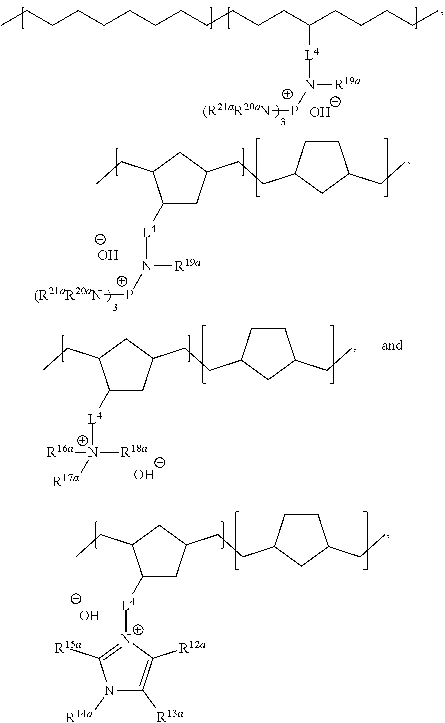
R, R^{1a}, R^{2a}, R^{3a}, R^{4a}, R^{5a}, R^{7a}, R^{8a}, R^{9a}, R^{11a}, R^{12a}, R^{13a}, R^{14a}, R^{15a}, R^{16a}, R^{17a}, R^{18a}, R^{19a}, R^{20a}, and R^{21a} is each independently selected from H, a C₁₋₃ alkyl, C₆₋₁₂ aryl, and C₅₋₁₂ cycloalkyl,
L⁴ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₚ, (C₁₋₁₂ alkylene-O)ₚ, C(O)(O—C₁₋₁₂ alkylene)ₚ, OC(O)(C₁₋₁₂ alkylene)ₚ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₚ, (NH)C(O—C₁₋₁₂ alkylene)ₚ, (NH—C₁₋₁₂ alkylene)ₚ, (C₁₋₁₂ alkylene-NH)ₚ, and a bond;
p is an integer between 1 and 6; and
each moiety within square brackets represents a repeat unit of the second ionomer.

32. The MEA of any one of claims 1-27, wherein the support is a porous transport layer (PTL).

33. The MEA of claim 32, wherein the PTL comprises a metal foam, metal fiber, metal felt, metal sintered fiber felt, expanded metal, stainless steel, carbon paper, carbon fiber paper, woven carbon fiber cloth, and graphite felt.

34. The MEA of claim 32, wherein the PTL comprises Ni or stainless steel.

35. A method of making an MEA of any one of claims 1-34, comprising:
a) providing a suspension comprising a solution of a cross-linkable ionomer and the catalyst in a solvent,
b) contacting the support with the suspension, thereby producing a coated support, and
c) exposing the coated support to ultraviolet radiation for a time sufficient to cross-link the cross-linkable ionomer, wherein
the cross-linkable ionomer comprises:
a plurality of first repeat units represented by structural formula (III): 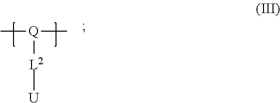
and
a plurality of second repeat units represented by structural formula (IV): 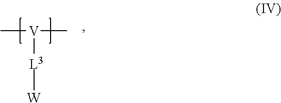
wherein: 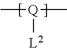
is a moiety represented by one of the following structural formulas: 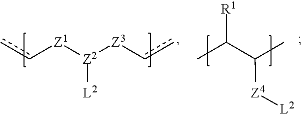
U is a moiety represented by one of the following structural formulas: 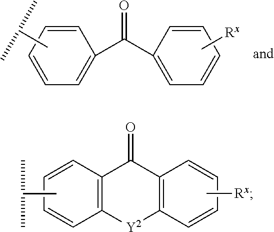 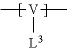
is a moiety represented by one of the following structural formulas: 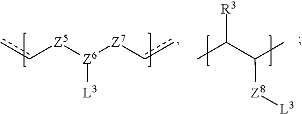
W is a C₁₋₁₂ alkyl or a moiety represented by one of the structural formulas selected from: 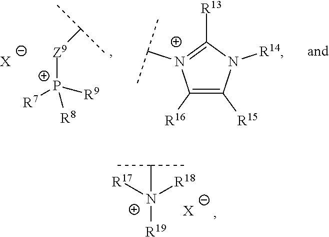
wherein:
the symbol [symbol] represents a point of attachment to L², the symbol [symbol] represents a point of attachment to L³, and the symbol [symbol] represents a double bond or a single bond;
Z¹, Z³, Z⁵, and Z⁷ each independently is a C₁₋₃ alkylene or a bond;
R¹ is selected from H, a C₁₋₁₂ alkyl, and C₆₋₁₂ aryl, and
Z⁴ is a bond or a C₆₋₁₂ arylene, or
Z⁴ is CH, and R¹ and Z⁴ together with the C₂ alkylene to which they are attached form a C₅₋₁₂ cycloalkyl or a 5 to 12-membered heterocyclyl; and
Z⁶ is selected from —CHR⁶—, a C₅₋₁₂ cycloalkylene, and a 5 to 16-membered heterocyclylene;
R³ is selected from H, a C₁₋₁₂ alkyl, and C₆₋₁₂ aryl, and
Z⁸ is a bond or a C₆₋₁₂ arylene, and CH, or
Z⁸ is CH, and R³ and Z⁸ together with the C₂ alkylene to which they are attached form a C₅₋₁₂ cycloalkyl or a 5 to 12-membered heterocyclyl; and
Z⁹ is NR¹⁰ or a bond;
R⁵ and R⁶ each independently is H or a C₁₋₁₂ alkyl;
R⁷, R⁸, and R⁹ each independently is selected from NR¹¹R¹², a C₆₋₁₂ aryl, and 5 to 12-membered heterocyclyl;
R¹⁰ is a C₁₋₁₂ alkyl;
R¹¹ and R¹² each independently is C₁₋₁₂ alkyl or a C₃₋₁₂ cycloalkyl, or R¹¹ and R¹² together with the nitrogen atom to which they are attached form a 5 to 12-membered heterocyclyl;
R¹³ is selected from a C₁₋₁₂ alkyl, C₆₋₁₂ aryl, and 5 to 12-membered heterocyclyl;
R¹⁴ is a C₁₋₁₂ alkyl or a C₃₋₁₂ cycloalkyl;
R¹⁵ and R¹⁶ each independently is selected from C₁₋₁₂ alkyl, C₆₋₁₂ aryl, and 5 to 12-membered heterocyclyl; or R¹⁵ and R¹⁶ together with the carbon atoms to which they are attached form a C₆₋₁₂ aryl or a 5 to 12-membered heterocyclyl; and
R¹⁷, R¹⁸, and R¹⁹ each independently is a C₁₋₁₂ alkyl or a C₃₋₁₂ cycloalkyl; or
R¹⁸ and R¹⁹ together with the nitrogen atom to which they are attached form a 5 to 12-membered heterocyclyl and (i) R¹⁷ is a C₁₋₁₂ alkyl or a C₃₋₁₂ cycloalkyl, or (ii) R¹⁷ and at least one atom of L³ together with the nitrogen atom to which L³ and R¹⁷ are attached form a 5- to 12-membered heterocyclyl; or
R¹⁷, R¹⁸, and R¹⁹ together with the nitrogen atom to which they are attached form a bicyclic 5 to 12-membered heterocyclyl; and
R^{x} is selected from H, F, Cl, Br, OH, NH₂, NO₂, CN, C₁₋₁₂ alkyl, C₆₋₁₂ aryl, and 5 to 12-membered heterocyclyl, and 5 to 12-membered heteroaryl;
L² is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₘ, (C₁₋₁₂ alkylene-O)ₘ, C(O)(O—C₁₋₁₂ alkylene)ₘ, OC(O)(C₁₋₁₂ alkylene)ₘ, C₁₋₁₂ alkylene-NH—C₁₋₁₂ alkylene, C₁₋₁₂ alkylene-N(C₁₋₁₂ alkyl)-C₁₋₁₂ alkylene, C(O)(NH—C₁₋₁₂ alkylene)ₘ, (NH)C(O—C₁₋₁₂ alkylene)ₘ, (NH—C₁₋₁₂ alkylene)ₘ, and (C₁₋₁₂ alkylene-NH)ₘ;
L³ is selected from a C₁₋₁₂ alkylene, C₆₋₁₂ arylene, C₆₋₁₂ arylene-C₁₋₁₂ alkylene, C₁₋₁₂ alkylene-C₆₋₁₂ arylene, C₁₋₁₂ alkylene-O—C₁₋₁₂ alkylene, (O—C₁₋₁₂ alkylene)ₙ, (C₁₋₁₂ alkylene-O)ₙ, C(O)(O—C₁₋₁₂ alkylene)ₙ, OC(O)(C₁₋₁₂ alkylene)ₙ, C₁₋₁₂ alkylene-NH—C₁-12 alkylene, C₁₋₁₂ alkylene-N(C₁₋₁₂ alkyl)-C₁₋₁₂ alkylene, C(O)(NH—C₁₋₁₂ alkylene)ₙ, (NH)C(O—C₁₋₁₂ alkylene)ₙ, (NH—C₁₋₁₂ alkylene)ₙ, (C₁₋₁₂ alkylene-NH)ₙ, and a bond;
m is an integer between 1 and 6;
n is an integer between 1 and 6;
Y² is selected from —C(O)—, —O—, —S—, —NH—, —N(C₁₋₁₂ alkyl)-, and a bond;
X⁻ is selected from F⁻, Cl⁻, Br⁻, OH⁻, NO⁻₂, CN⁻, HCO₃⁻, CO₃²⁻, PF₆⁻, BF₄⁻, and a C₁₋₁₂ carboxylate;
provided that W is C₁₋₁₂ alkyl only when V is a cationic moiety,
and wherein:
each C₁₋₁₂ alkylene, C₆₋₁₂ arylene, C₅₋₁₂ cycloalkylene, 5 to 16-membered heterocyclylene, C₁₋₁₂ alkyl, C₃₋₁₂ cycloalkyl, C₅₋₁₂ cycloalkyl, C₆₋₁₂ aryl, and 5 to 12-membered heterocyclyl is independently optionally substituted with 1 to 6 substituents independently selected from the group consisting of F, Cl, Br, OH, NH₂, NO₂, oxo, CN, a C₁₋₁₂ alkyl, C₆₋₁₂ aryl, C₁₋₁₂haloalkyl, C₁₋₁₂ alkoxy, C₆₋₁₂ aryl, C₆₋₁₂ aryloxy, 5 to 12-membered heterocyclyl, 5 to 12-membered heteroaryl, NH(C₁₋₁₂ alkyl), N(C₁₋₁₂ alkyl)₂, OC(O)(C₁₋₁₂ alkyl), C(O)O(C₁₋₁₂ alkyl), S(O)₂(C₁₋₁₂ alkyl), S(O)₂(C₆₋₁₂ aryl), NHC(O)(C₁₋₁₂ alkyl), and C(O)NH(C₁₋₁₂ alkyl).

36. The method claim 35, wherein the solvent is selected from water, 2-propanol, 1-propanol, ethanol, dipropylene glycol, N-methyl-2-pyrrolidone, and dimethylsulfoxide, or a combination thereof.

37. The method of claim 35 or 36, wherein the solvent comprises water and 1-propanol.

38. The method of any one of claims 35-38, wherein the suspension comprises from about 0.1 wt. % to about 1 wt. % of the cross-linkable ionomer.

39. The method of claim 38, wherein the suspension comprises about 0.5 wt. % of the cross-linkable ionomer.

40. The method of any one of claims 35-39, wherein the ratio of the catalyst to the cross-linkable ionomer in the suspension is from about 1:1 to about 97:3 by weight.

41. The method of claim 40, wherein the ratio of the catalyst to the cross-linkable ionomer in the suspension is about 9:1 by weight.

42. The method of any one of claims 35-41, wherein the contacting comprises spray coating.

43. The method of any one of claims 35-42, wherein the coated support does not comprise an external radical initiator.

44. A fuel cell comprising an MEA of any one of claims 1-34, a source of fuel, and an oxidant.

45. The fuel cell of claim 44, wherein the fuel is humidified.

46. The fuel cell of claim 44 or 45, wherein the fuel is selected from hydrogen, methanol, ethanol, and ammonia.

47. The fuel cell of any one of claims 44-46, wherein the oxidant is oxygen.

48. An electrolyzer comprising an MEA of any one of claims 1-34 and an electrolyte source.

49. The electrolyzer of claim 48, wherein the electrolyte source comprises water, a metal hydroxide, ethanol, methanol, ammonia, carbon dioxide, or a combination thereof.
